(19) United States
(12) Patent Application Publication
(10) Pub. No.: US 2025/0157342 A1
(43) Pub. Date: May 15, 2025

(54) UAV Route Planning for Mitigating Traffic Encounters

(71) Applicant: Wing Aviation LLC, Palo Alto, CA (US)

(72) Inventors: Kevin Jenkins, Dallas, TX (US); John Gordon Mooney, Athens, GA (US); Anthony Robert Nannini, Redwood City, CA (US)

(21) Appl. No.: 18/506,921

(22) Filed: Nov. 10, 2023

(51) Int. Cl. G08G 5/00; G08G 5/04

(52) U.S. Cl. CPC G08G 5/34; G08G 5/55; G08G 5/57; G08G 5/59; G08G 5/80

(57) ABSTRACT

A method is disclosed. The method includes receiving data for one or more aircraft currently flying within an airspace. The received data for each of the one or more aircraft includes a current position and at least one aircraft parameter. Based on the current position and the at least one aircraft parameter, the method also includes determining an initial volume and a predicted future trajectory for each of the one or more aircraft. The method additionally includes determining, based on the predicted future trajectory and the initial volume, an extended volume for each of the one or more aircraft. The method further includes determining, based on the extended volume determined for each of the one or more aircraft, a composite extended volume space. The method includes planning a flight path for an unmanned aerial vehicle (UAV) through the airspace based on the composite extended volume space.

### BACKGROUND

An uncrewed vehicle, which may also be referred to as an autonomous vehicle, is a vehicle capable of travel without a physically-present human operator. An uncrewed vehicle may operate in a remote-control mode, in an autonomous mode, or in a partially autonomous mode.

When an uncrewed vehicle operates in a remote-control mode, a pilot or driver that is at a remote location can control the uncrewed vehicle via commands that are sent to the uncrewed vehicle via a wireless link. When the uncrewed vehicle operates in autonomous mode, the uncrewed vehicle typically moves based on pre-programmed navigation waypoints, dynamic automation systems, or a combination of these. Further, some uncrewed vehicles can operate in both a remote-control mode and an autonomous mode, and in some instances may do so simultaneously. For instance, a remote pilot or driver may wish to leave navigation to an autonomous system while manually performing another task, such as operating a mechanical system for picking up objects, as an example.

Various types of uncrewed vehicles exist for various different environments. For instance, uncrewed vehicles exist for operation in the air, on the ground, underwater, and in space. Examples include quad-copters and tail-sitter UAVs, among others. uncrewed vehicles also exist for hybrid operations in which multi-environment operation is possible. Examples of hybrid uncrewed vehicles include an amphibious craft that is capable of operation on land as well as on water or a floatplane that is capable of landing on water as well as on land. Other examples are also possible.

### SUMMARY

Examples disclosed herein include methods for mitigating expected traffic encounters with aircraft flying within an airspace. Data may be received for one or more aircraft currently flying within the airspace. The received data for each of the one or more aircraft may include a current position and at least one aircraft parameter. Based on the current position and the at least one aircraft parameter an initial volume and a predicted future trajectory may be determined for each of the one or more aircraft. Based on the predicted future trajectory and the initial volume, an extended volume may be determined for each of the one or more aircraft. Based on the extended volume determined for each of the one or more aircraft, a composite extended volume space may be determined. Based on the composite extended volume space, a flight path for an unmanned aerial vehicle (UAV) may be planned through the airspace.

In a first aspect, a method includes receiving data for one or more aircraft currently flying within an airspace. The received data includes, for each of the one or more aircraft, a current position and at least one aircraft parameter. The method also includes, determining, based on the current position and the at least one aircraft parameter, an initial volume for each of the one or more aircraft. The method further includes, determining, based on the current position and the at least one aircraft parameter, a predicted future trajectory for each of the one or more aircraft. The method additionally includes, determining, based on the predicted future trajectory and the initial volume, an extended volume for each of the one or more aircraft. The method also includes determining, based on the extended volume determined for each of the one or more aircraft, a composite extended volume space. The method includes planning a flight path for an unmanned aerial vehicle (UAV) through the airspace based on the composite extended volume space.

In a second aspect, a system includes a processor and a non-transitory data storage storing program instructions executable by the processor to carry out operations. The operations include receiving data for one or more aircraft currently flying within an airspace. The received data includes, for each of the one or more aircraft, a current position and at least one aircraft parameter. The operations also include determining, based on the current position and the at least one aircraft parameter, an initial volume for each of the one or more aircraft. The operations further include determining, based on the current position and the at least one aircraft parameter, a predicted future trajectory for each of the one or more aircraft. The operations additionally include determining, based on the predicted future trajectory and the initial volume, an extended volume for each of the one or more aircraft. The operations also include determining, based on the extended volume determined for each of the one or more aircraft, a composite extended volume space. The operations include planning a flight path for an unmanned aerial vehicle (UAV) through the airspace based on the composite extended volume space.

In a third aspect, non-transitory computer-readable medium having stored thereon program instructions executable by a processor of a device to cause the device to carry out operations that include receiving data for one or more aircraft currently flying within an airspace. The received data includes, for each of the one or more aircraft, a current position and at least one aircraft parameter. The operations also include determining, based on the current position and the at least one aircraft parameter, an initial volume for each of the one or more aircraft. The operations further include determining, based on the current position and the at least one aircraft parameter, a predicted future trajectory for each of the one or more aircraft. The operations additionally include determining, based on the predicted future trajectory and the initial volume, an extended volume for each of the one or more aircraft. The operations also include determining, based on the extended volume determined for each of the one or more aircraft, a composite extended volume space. The operations include planning a flight path for an unmanned aerial vehicle (UAV) through the airspace based on the composite extended volume space.

In a further aspect, a system includes means for receiving data for one or more aircraft currently flying within an airspace, where the received data includes a current position and at least one aircraft parameter, for each of the one or more aircraft. The system further includes means for determining, based on the current position and the at least one aircraft parameter, an initial volume for each of the one or more aircraft. The system also includes means for determining, based on the current position and the at least one aircraft parameter, a predicted future trajectory for each of the one or more aircraft. The system additionally includes means for determining, based on the predicted future trajectory and the initial volume, an extended volume for each of the one or more aircraft. The system also includes means for determining, based on the extended volume determined for each of the one or more aircraft, a composite extended volume space. The system further includes means for planning a flight path for an unmanned aerial vehicle (UAV) through the airspace based on the composite extended volume space.

These, as well as other aspects, advantages, and alternatives, will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1A is a simplified illustration of an uncrewed aerial vehicle, according to example embodiments, in accordance with example embodiments.

FIG. 1B is a simplified illustration of an uncrewed aerial vehicle, according to example embodiments, in accordance with example embodiments.

FIG. 1C is a simplified illustration of an uncrewed aerial vehicle, according to example embodiments, in accordance with example embodiments.

FIG. 1D is a simplified illustration of an uncrewed aerial vehicle, according to example embodiments, in accordance with example embodiments.

FIG. 1E is a simplified illustration of an uncrewed aerial vehicle, according to example embodiments, in accordance with example embodiments.

FIG. 2 is a simplified block diagram illustrating components of an uncrewed aerial vehicle, in accordance with example embodiments.

FIG. 3 is a simplified block diagram illustrating a UAV system, in accordance with example embodiments.

FIG. 4 is a simplified block diagram of traffic encounter mitigation functions within an airspace, in accordance with example embodiments.

FIG. 5 is an illustration of an initial volume for an aircraft, in accordance with example embodiments.

FIGS. 6A-6B are further illustrations of initial volumes for an aircraft, in accordance with example embodiments.

FIG. 7 is an illustration of an extended volume along a predicted future trajectory of an aircraft, in accordance with example embodiments.

FIG. 8 is a top view illustration of a predicted traffic encounter between a UAV and an aircraft, in accordance with example embodiments.

FIG. 9 is a composite extended volume space for an airspace, in accordance with example embodiments.

FIG. 10 is a mitigated traffic encounter scenario for an airspace that includes a plurality of airspace parameters, in accordance with example embodiments.

FIG. 11 is a simplified block diagram of a method, in accordance with example embodiments.

### DETAILED DESCRIPTION

Exemplary methods and systems are described herein. It should be understood that the word “exemplary” is used herein to mean “serving as an example, instance, or illustration.” Any implementation or feature described herein as “exemplary” or “illustrative” is not necessarily to be construed as preferred or advantageous over other implementations or features. In the figures, similar symbols typically identify similar components, unless context dictates otherwise. The example implementations described herein are not meant to be limiting. It will be readily understood that the aspects of the present disclosure, as generally described herein, and illustrated in the figures, can be arranged, substituted, combined, separated, and designed in a wide variety of different configurations, all of which are contemplated herein.

Throughout this description, the articles “a” or “an” are used to introduce elements of the example embodiments. Any reference to “a” or “an” refers to “at least one,” and any reference to “the” refers to “the at least one,” unless otherwise specified, or unless the context clearly dictates otherwise. The intent of using the conjunction “or” within a described list of at least two terms is to indicate any of the listed terms or any combination of the listed terms.

The use of ordinal numbers such as “first,” “second,” “third” and so on is to distinguish respective elements rather than to denote a particular order of those elements. For the purposes of this description, the terms “multiple” and “a plurality of” refer to “two or more” or “more than one.”

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment. In the figures, similar symbols typically identify similar components, unless context dictates otherwise. Further, unless otherwise noted, figures are not drawn to scale and are used for illustrative purposes only. Moreover, the figures are representational only and not all components are shown. For example, additional structural or restraining components might not be shown.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Overview

An example usage of UAVs may be to deliver various items to customers. For example, a UAV may be tasked with picking up a payload containing an item from a location and delivering the payload to a customer's residence, commercial building, or other location. One potential problem that might arise in this delivery process is the UAV may encounter another aircraft (e.g., a crewed aircraft or another uncrewed aircraft) operating in the same vicinity as the UAV flying along a flight path. Operating in close proximity with the aircraft may create a risk of collision between the other aircraft and the UAV. Collision between the UAV and the aircraft may present a safety risk, as well as potentially damaging the UAV and/or the aircraft.

Therefore, it may be desirable to reduce a likelihood of encountering aircraft along the flight path. For example, aircraft data for aircraft operating within an airspace could be used to predict aircraft trajectories and a flight path for the UAV could be planned to not intersect with predicted aircraft trajectories.

Provided herein are methods for flight path planning operations of the UAV for mitigating potential traffic encounters between the UAV and the aircraft operating in the airspace of the UAV. In some examples, data may be received for one or more aircraft currently flying within the airspace. The data may include the current position and at least one aircraft parameter for each of the one or more aircraft. The at least one aircraft parameter may include dynamic information (e.g., information that may change while in the airspace) about the aircraft, such as velocity, heading, and/or altitude, and/or static information (e.g., information that may remain constraint while in the airspace) about the aircraft, such as aircraft identifiers, aircraft type/configuration, tail number, and/or flight history. The current position and at least one aircraft parameter may be used to determine an initial volume surrounding the current position of the aircraft. The initial volume may represent a zone of uncertainty around the current position of the aircraft. The current position and the at least one aircraft parameter may be used to determine a predicted future trajectory for the aircraft. The predicted future trajectory may represent a flight path that the aircraft is predicted to travel along while in the airspace. An extended volume may be determined from the predicted future trajectory and the initial volume. The extended volume may represent a zone around the predicted future trajectory that allots for a level of uncertainty of the aircraft's position while flying within the airspace. The extended volume may be determined for each aircraft operating within the airspace. Each of the extended volumes may be compiled to form a composite extended volume space that accounts for the predicted future trajectory of each aircraft operating within the airspace. The composite extended volume space may be used to plan a flight path for the UAV through the airspace. By predicting the trajectory of aircraft within the airspace and providing a zone around the predicted trajectory that allows for uncertainty of the aircraft's position, the flight path of the UAV may be better able to overcome challenges associated with operating within an airspace that includes human controlled aircraft.

In some examples, each of the extended volume spaces includes a reservation time, where the extended volume space is determined to be resolved at expiration of the reservation time. A starting point and an ending point of the planned flight path of the UAV may be used to determine a time required for the UAV to reach each point of a plurality of points along the planned flight path. Based on whether the reservation time for each extended volume space will expire prior to the time required for the UAV to reach the extended volume space, it may be determined whether the planned flight path intersects with at least one of the extended volumes.

### II. Example Uncrewed Vehicles

Herein, the terms “uncrewed aerial vehicle” and “UAV” refer to any autonomous or semi-autonomous vehicle that is capable of performing some functions without a physically present human pilot. As would be understood by one of skill in the art, uncrewed and unmanned may be used interchangeably.

A UAV can take various forms. For example, a UAV may take the form of a fixed-wing aircraft, a glider aircraft, a tail-sitter aircraft, a jet aircraft, a ducted fan aircraft, a lighter-than-air dirigible such as a blimp or steerable balloon, a rotorcraft such as a helicopter or multicopter, and/or an ornithopter, among other possibilities. Further, the terms “drone,” “uncrewed aerial vehicle system” (UAVS), or “uncrewed aerial system” (UAS) may also be used to refer to a UAV.

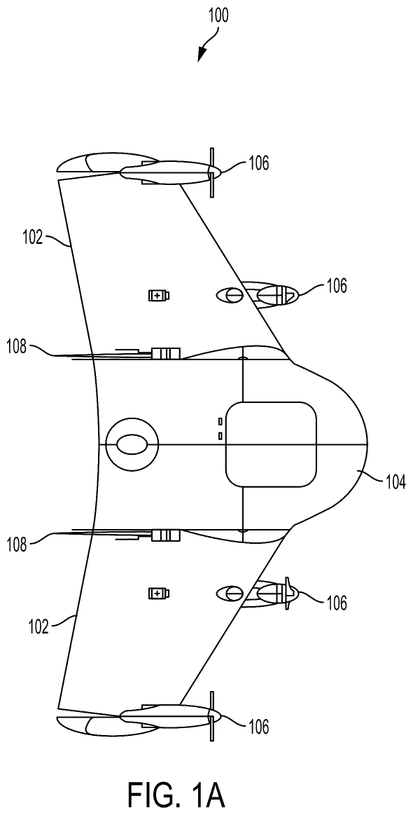

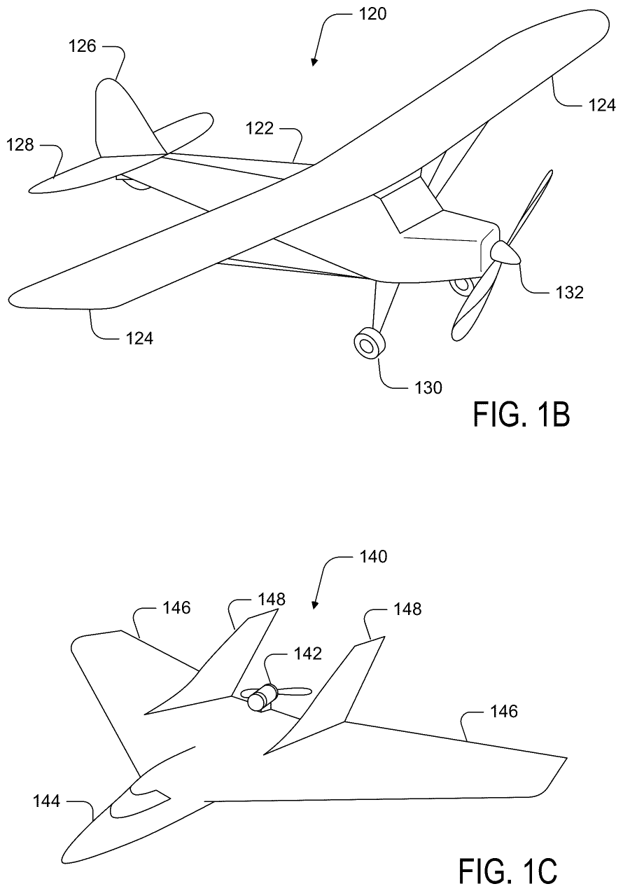

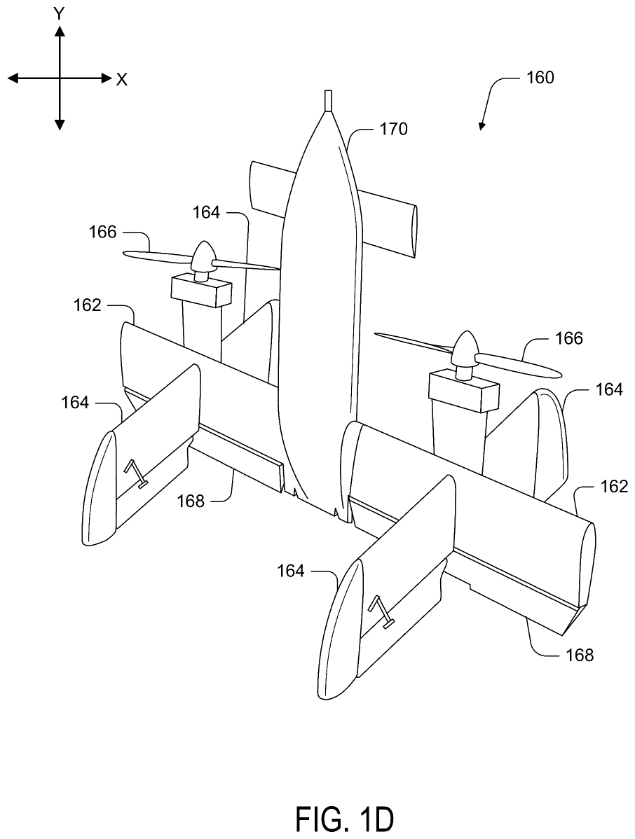

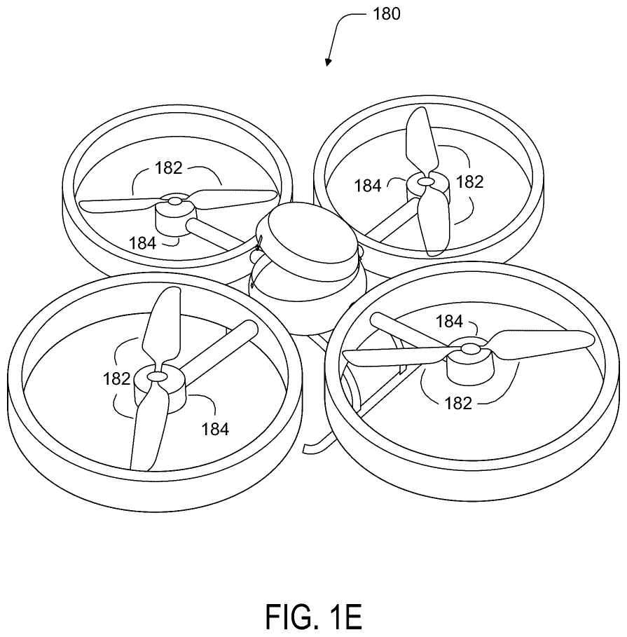

FIG. 1A is an isometric view of an example UAV 100. UAV 100 includes wing 102, booms 104, and a fuselage 106. Wings 102 may be stationary and may generate lift based on the wing shape and the UAV's forward airspeed. For instance, the two wings 102 may have an airfoil-shaped cross section to produce an aerodynamic force on UAV 100. In some embodiments, wing 102 may carry horizontal propulsion units 108, and booms 104 may carry vertical propulsion units 110. In operation, power for the propulsion units may be provided from a battery compartment 112 of fuselage 106. In some embodiments, fuselage 106 also includes an avionics compartment 114, an additional battery compartment (not shown) and/or a delivery unit (not shown, e.g., a winch system) for handling the payload. In some embodiments, fuselage 106 is modular, and two or more compartments (e.g., battery compartment 112, avionics compartment 114, other payload and delivery compartments) are detachable from each other and securable to each other (e.g., mechanically, magnetically, or otherwise) to contiguously form at least a portion of fuselage 106.

In some embodiments, booms 104 terminate in rudders 116 for improved yaw control of UAV 100. Further, wings 102 may terminate in wing tips 117 for improved control of lift of the UAV.

In the illustrated configuration, UAV 100 includes a structural frame. The structural frame may be referred to as a “structural H-frame” or an “H-frame” (not shown) of the UAV. The H-frame may include, within wings 102, a wing spar (not shown) and, within booms 104, boom carriers (not shown). In some embodiments the wing spar and the boom carriers may be made of carbon fiber, hard plastic, aluminum, light metal alloys, or other materials. The wing spar and the boom carriers may be connected with clamps. The wing spar may include pre-drilled holes for horizontal propulsion units 108, and the boom carriers may include pre-drilled holes for vertical propulsion units 110.

In some embodiments, fuselage 106 may be removably attached to the H-frame (e.g., attached to the wing spar by clamps, configured with grooves, protrusions or other features to mate with corresponding H-frame features, etc.). In other embodiments, fuselage 106 similarly may be removably attached to wings 102. The removable attachment of fuselage 106 may improve quality and or modularity of UAV 100. For example, electrical/mechanical components and/or subsystems of fuselage 106 may be tested separately from, and before being attached to, the H-frame. Similarly, printed circuit boards (PCBs) 118 may be tested separately from, and before being attached to, the boom carriers, therefore eliminating defective parts/subassemblies prior to completing the UAV. For example, components of fuselage 106 (e.g., avionics, battery unit, delivery units, an additional battery compartment, etc.) may be electrically tested before fuselage 106 is mounted to the H-frame. Furthermore, the motors and the electronics of PCBs 118 may also be electrically tested before the final assembly. Generally, the identification of the defective parts and subassemblies early in the assembly process lowers the overall cost and lead time of the UAV. Furthermore, different types/models of fuselage 106 may be attached to the H-frame, therefore improving the modularity of the design. Such modularity allows these various parts of UAV 100 to be upgraded without a substantial overhaul to the manufacturing process.

In some embodiments, a wing shell and boom shells may be attached to the H-frame by adhesive elements (e.g., adhesive tape, double-sided adhesive tape, glue, etc.). Therefore, multiple shells may be attached to the H-frame instead of having a monolithic body sprayed onto the H-frame. In some embodiments, the presence of the multiple shells reduces the stresses induced by the coefficient of thermal expansion of the structural frame of the UAV. As a result, the UAV may have better dimensional accuracy and/or improved reliability.

Moreover, in at least some embodiments, the same H-frame may be used with the wing shell and/or boom shells having different size and/or design, therefore improving the modularity and versatility of the UAV designs. The wing shell and/or the boom shells may be made of relatively light polymers (e.g., closed cell foam) covered by the harder, but relatively thin, plastic skins.

The power and/or control signals from fuselage 106 may be routed to PCBs 118 through cables running through fuselage 106, wings 102, and booms 104. In the illustrated embodiment, UAV 100 has four PCBs, but other numbers of PCBs are also possible. For example, UAV 100 may include two PCBs, one per the boom. The PCBs carry electronic components 119 including, for example, power converters, controllers, memory, passive components, etc. In operation, propulsion units 108 and 110 of UAV 100 are electrically connected to the PCBs.

Many variations on the illustrated UAV are possible. For instance, fixed-wing UAVs may include more or fewer rotor units (vertical or horizontal), and/or may utilize a ducted fan or multiple ducted fans for propulsion. Further, UAVs with more wings (e.g., an “x-wing” configuration with four wings), are also possible. Although FIG. 1 illustrates two wings 102, two booms 104, two horizontal propulsion units 108, and six vertical propulsion units 110 per boom 104, it should be appreciated that other variants of UAV 100 may be implemented with more or less of these components. For example, UAV 100 may include four wings 102, four booms 104, and more or less propulsion units (horizontal or vertical).

Similarly, FIG. 1B shows another example of a fixed-wing UAV 120. The fixed-wing UAV 120 includes a fuselage 122, two wings 124 with an airfoil-shaped cross section to provide lift for the UAV 120, a vertical stabilizer 126 (or fin) to stabilize the plane's yaw (turn left or right), a horizontal stabilizer 128 (also referred to as an elevator or tailplane) to stabilize pitch (tilt up or down), landing gear 130, and a propulsion unit 132, which can include a motor, shaft, and propeller.

FIG. 1C shows an example of a UAV 140 with a propeller in a pusher configuration. The term “pusher” refers to the fact that a propulsion unit 142 is mounted at the back of the UAV and “pushes” the vehicle forward, in contrast to the propulsion unit being mounted at the front of the UAV. Similar to the description provided for FIGS. 1A and 1B, FIG. 1C depicts common structures used in a pusher plane, including a fuselage 144, two wings 146, vertical stabilizers 148, and the propulsion unit 142, which can include a motor, shaft, and propeller.

FIG. 1D shows an example of a tail-sitter UAV 160. In the illustrated example, the tail-sitter UAV 160 has fixed wings 162 to provide lift and allow the UAV 160 to glide horizontally (e.g., along the x-axis, in a position that is approximately perpendicular to the position shown in FIG. 1D). However, the fixed wings 162 also allow the tail-sitter UAV 160 to take off and land vertically on its own.

For example, at a launch site, the tail-sitter UAV 160 may be positioned vertically (as shown) with its fins 164 and/or wings 162 resting on the ground and stabilizing the UAV 160 in the vertical position. The tail-sitter UAV 160 may then take off by operating its propellers 166 to generate an upward thrust (e.g., a thrust that is generally along the y-axis). Once at a suitable altitude, the tail-sitter UAV 160 may use its flaps 168 to reorient itself in a horizontal position, such that its fuselage 170 is closer to being aligned with the x-axis than the y-axis. Positioned horizontally, the propellers 166 may provide forward thrust so that the tail-sitter UAV 160 can fly in a similar manner as a typical airplane.

Many variations on the illustrated fixed-wing UAVs are possible. For instance, fixed-wing UAVs may include more or fewer propellers, and/or may utilize a ducted fan or multiple ducted fans for propulsion. Further, UAVs with more wings (e.g., an “x-wing” configuration with four wings), with fewer wings, or even with no wings, are also possible.

As noted above, some embodiments may involve other types of UAVs, in addition to or in the alternative to fixed-wing UAVs. For instance, FIG. 1E shows an example of a rotorcraft that is commonly referred to as a multicopter 180. The multicopter 180 may also be referred to as a quadcopter, as it includes four rotors 182. It should be understood that example embodiments may involve a rotorcraft with more or fewer rotors than the multicopter 180. For example, a helicopter typically has two rotors. Other examples with three or more rotors are possible as well. Herein, the term “multicopter” refers to any rotorcraft having more than two rotors, and the term “helicopter” refers to rotorcraft having two rotors.

Referring to the multicopter 180 in greater detail, the four rotors 182 provide propulsion and maneuverability for the multicopter 180. More specifically, each rotor 182 includes blades that are attached to a motor 184. Configured as such, the rotors 182 may allow the multicopter 180 to take off and land vertically, to maneuver in any direction, and/or to hover. Further, the pitch of the blades may be adjusted as a group and/or differentially, and may allow the multicopter 180 to control its pitch, roll, yaw, and/or altitude.

It should be understood that references herein to an “unamnned” aerial vehicle or UAV can apply equally to autonomous and semi-autonomous aerial vehicles. In an autonomous implementation, all functionality of the aerial vehicle is automated; e.g., pre-programmed or controlled via real-time computer functionality that responds to input from various sensors and/or pre-determined information. In a semi-autonomous implementation, some functions of an aerial vehicle may be controlled by a human operator, while other functions are carried out autonomously. Further, in some embodiments, a UAV may be configured to allow a remote operator to take over functions that can otherwise be controlled autonomously by the UAV. Yet further, a given type of function may be controlled remotely at one level of abstraction and performed autonomously at another level of abstraction. For example, a remote operator could control high level navigation decisions for a UAV, such as by specifying that the UAV should travel from one location to another (e.g., from a warehouse in a suburban area to a delivery address in a nearby city), while the UAV's navigation system autonomously controls more fine-grained navigation decisions, such as the specific route to take between the two locations, specific flight controls to achieve the route and avoid obstacles while navigating the route, and so on.

More generally, it should be understood that the example UAVs described herein are not intended to be limiting. Example embodiments may relate to, be implemented within, or take the form of any type of uncrewed aerial vehicle.

### III. Illustrative UAV Components

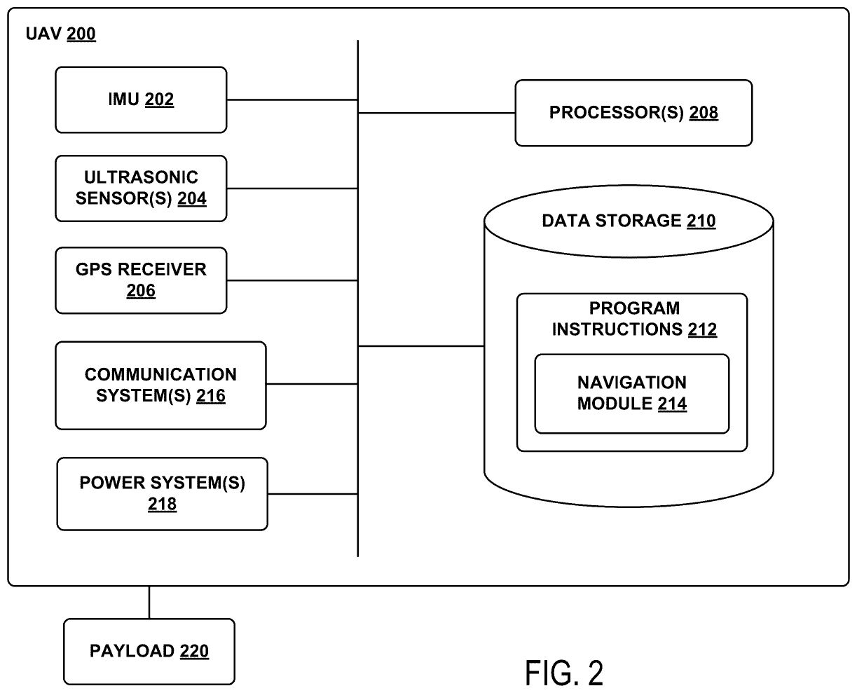

FIG. 2 is a simplified block diagram illustrating components of a UAV 200, according to an example embodiment. UAV 200 may take the form of, or be similar in form to, one of the UAVs 100, 120, 140, 160, and 180 described in reference to FIGS. 1A-1E. However, UAV 200 may also take other forms.

UAV 200 may include various types of sensors, and may include a computing system configured to provide the functionality described herein. In the illustrated embodiment, the sensors of UAV 200 include an inertial measurement unit (IMU) 202, ultrasonic sensor(s) 204, and a GPS 206, among other possible sensors and sensing systems.

In the illustrated embodiment, UAV 200 also includes one or more processors 208. A processor 208 may be a general-purpose processor or a special purpose processor (e.g., digital signal processors, application specific integrated circuits, etc.). The one or more processors 208 can be configured to execute computer-readable program instructions 212 that are stored in the data storage 210 and are executable to provide the functionality of a UAV described herein.

The data storage 210 may include or take the form of one or more computer-readable storage media that can be read or accessed by at least one processor 208. The one or more computer-readable storage media can include volatile and/or non-volatile storage components, such as optical, magnetic, organic or other memory or disc storage, which can be integrated in whole or in part with at least one of the one or more processors 208. In some embodiments, the data storage 210 can be implemented using a single physical device (e.g., one optical, magnetic, organic or other memory or disc storage unit), while in other embodiments, the data storage 210 can be implemented using two or more physical devices.

As noted, the data storage 210 can include computer-readable program instructions 212 and perhaps additional data, such as diagnostic data of the UAV 200. As such, the data storage 210 may include program instructions 212 to perform or facilitate some or all of the UAV functionality described herein. For instance, in the illustrated embodiment, program instructions 212 include a navigation module 214 and a tether control module 216.

### A. Sensors

In an illustrative embodiment, IMU 202 may include both an accelerometer and a gyroscope, which may be used together to determine an orientation of the UAV 200. In particular, the accelerometer can measure the orientation of the vehicle with respect to earth, while the gyroscope measures the rate of rotation around an axis. IMUs are commercially available in low-cost, low-power packages. For instance, an IMU 202 may take the form of or include a miniaturized MicroElectroMechanical System (MEMS) or a NanoElectroMechanical System (NEMS). Other types of IMUs may also be utilized.

An IMU 202 may include other sensors, in addition to accelerometers and gyroscopes, which may help to better determine position and/or help to increase autonomy of the UAV 200. Two examples of such sensors are magnetometers and pressure sensors. In some embodiments, a UAV may include a low-power, digital 3-axis magnetometer, which can be used to realize an orientation independent electronic compass for accurate heading information. However, other types of magnetometers may be utilized as well. Other examples are also possible. Further, note that a UAV could include some or all of the above-described inertia sensors as separate components from an IMU.

UAV 200 may also include a pressure sensor or barometer, which can be used to determine the altitude of the UAV 200. Alternatively, other sensors, such as sonic altimeters or radar altimeters, can be used to provide an indication of altitude, which may help to improve the accuracy of and/or prevent drift of an IMU.

In a further aspect, UAV 200 may include one or more sensors that allow the UAV to sense objects in the environment. For instance, in the illustrated embodiment, UAV 200 includes ultrasonic sensor(s) 204. Ultrasonic sensor(s) 204 can determine the distance to an object by generating sound waves and determining the time interval between transmission of the wave and receiving the corresponding echo off an object. A typical application of an ultrasonic sensor for uncrewed vehicles or IMUs is low-level altitude control and obstacle avoidance. An ultrasonic sensor can also be used for vehicles that need to hover at a certain height or need to be capable of detecting obstacles. Other systems can be used to determine, sense the presence of, and/or determine the distance to nearby objects, such as a light detection and ranging (LIDAR) system, laser detection and ranging (LADAR) system, and/or an infrared or forward-looking infrared (FLIR) system, among other possibilities.

In some embodiments, UAV 200 may also include one or more imaging system(s). For example, one or more still and/or video cameras may be utilized by UAV 200 to capture image data from the UAV's environment. As a specific example, charge-coupled device (CCD) cameras or complementary metal-oxide-semiconductor (CMOS) cameras can be used with uncrewed vehicles. Such imaging sensor(s) have numerous possible applications, such as obstacle avoidance, localization techniques, ground tracking for more accurate navigation (e.g., by applying optical flow techniques to images), video feedback, and/or image recognition and processing, among other possibilities.

UAV 200 may also include a GPS receiver 206. The GPS receiver 206 may be configured to provide data that is typical of well-known GPS systems, such as the GPS coordinates of the UAV 200. Such GPS data may be utilized by the UAV 200 for various functions. As such, the UAV may use its GPS receiver 206 to help navigate to the caller's location, as indicated, at least in part, by the GPS coordinates provided by their mobile device. Other examples are also possible.

### B. Navigation and Location Determination

The navigation module 214 may provide functionality that allows the UAV 200 to, e.g., move about its environment and reach a desired location. To do so, the navigation module 214 may control the altitude and/or direction of flight by controlling the mechanical features of the UAV that affect flight (e.g., its rudder(s), elevator(s), aileron(s), and/or the speed of its propeller(s)).

In order to navigate the UAV 200 to a target location, the navigation module 214 may implement various navigation techniques, such as map-based navigation and localization-based navigation, for instance. With map-based navigation, the UAV 200 may be provided with a map of its environment, which may then be used to navigate to a particular location on the map. With localization-based navigation, the UAV 200 may be capable of navigating in an unknown environment using localization. Localization-based navigation may involve the UAV 200 building its own map of its environment and calculating its position within the map and/or the position of objects in the environment. For example, as a UAV 200 moves throughout its environment, the UAV 200 may continuously use localization to update its map of the environment. This continuous mapping process may be referred to as simultaneous localization and mapping (SLAM). Other navigation techniques may also be utilized.

In some embodiments, the navigation module 214 may navigate using a technique that relies on waypoints. In particular, waypoints are sets of coordinates that identify points in physical space. For instance, an air-navigation waypoint may be defined by a certain latitude, longitude, and altitude. Accordingly, navigation module 214 may cause UAV 200 to move from waypoint to waypoint, in order to ultimately travel to a final destination (e.g., a final waypoint in a sequence of waypoints).

In a further aspect, the navigation module 214 and/or other components and systems of the UAV 200 may be configured for “localization” to more precisely navigate to the scene of a target location. More specifically, it may be desirable in certain situations for a UAV to be within a threshold distance of the target location where a payload 228 is being delivered by a UAV (e.g., within a few feet of the target destination). To this end, a UAV may use a two-tiered approach in which it uses a more-general location-determination technique to navigate to a general area that is associated with the target location, and then use a more-refined location-determination technique to identify and/or navigate to the target location within the general area.

For example, the UAV 200 may navigate to the general area of a target destination where a payload 228 is being delivered using waypoints and/or map-based navigation. The UAV may then switch to a mode in which it utilizes a localization process to locate and travel to a more specific location. For instance, if the UAV 200 is to deliver a payload to a user's home, the UAV 200 may need to be substantially close to the target location in order to avoid delivery of the payload to undesired areas (e.g., onto a roof, into a pool, onto a neighbor's property, etc.). However, a GPS signal may only get the UAV 200 so far (e.g., within a block of the user's home). A more precise location-determination technique may then be used to find the specific target location.

Various types of location-determination techniques may be used to accomplish localization of the target delivery location once the UAV 200 has navigated to the general area of the target delivery location. For instance, the UAV 200 may be equipped with one or more sensory systems, such as, for example, ultrasonic sensors 204, infrared sensors (not shown), and/or other sensors, which may provide input that the navigation module 214 utilizes to navigate autonomously or semi-autonomously to the specific target location.

As another example, once the UAV 200 reaches the general area of the target delivery location (or of a moving subject such as a person or their mobile device), the UAV 200 may switch to a “fly-by-wire” mode where it is controlled, at least in part, by a remote operator, who can navigate the UAV 200 to the specific target location. To this end, sensory data from the UAV 200 may be sent to the remote operator to assist them in navigating the UAV 200 to the specific location.

As yet another example, the UAV 200 may include a module that is able to signal to a passer-by for assistance in either reaching the specific target delivery location; for example, the UAV 200 may display a visual message requesting such assistance in a graphic display, play an audio message or tone through speakers to indicate the need for such assistance, among other possibilities. Such a visual or audio message might indicate that assistance is needed in delivering the UAV 200 to a particular person or a particular location, and might provide information to assist the passer-by in delivering the UAV 200 to the person or location (e.g., a description or picture of the person or location, and/or the person or location's name), among other possibilities. Such a feature can be useful in a scenario in which the UAV is unable to use sensory functions or another location-determination technique to reach the specific target location. However, this feature is not limited to such scenarios.

In some embodiments, once the UAV 200 arrives at the general area of a target delivery location, the UAV 200 may utilize a beacon from a user's remote device (e.g., the user's mobile phone) to locate the person. Such a beacon may take various forms. As an example, consider the scenario where a remote device, such as the mobile phone of a person who requested a UAV delivery, is able to send out directional signals (e.g., via an RF signal, a light signal and/or an audio signal). In this scenario, the UAV 200 may be configured to navigate by “sourcing” such directional signals—in other words, by determining where the signal is strongest and navigating accordingly. As another example, a mobile device can emit a frequency, either in the human range or outside the human range, and the UAV 200 can listen for that frequency and navigate accordingly. As a related example, if the UAV 200 is listening for spoken commands, then the UAV 200 could utilize spoken statements, such as “I'm over here!” to source the specific location of the person requesting delivery of a payload.

In an alternative arrangement, a navigation module may be implemented at a remote computing device, which communicates wirelessly with the UAV 200. The remote computing device may receive data indicating the operational state of the UAV 200, sensor data from the UAV 200 that allows it to assess the environmental conditions being experienced by the UAV 200, and/or location information for the UAV 200. Provided with such information, the remote computing device may determine latitudinal and/or directional adjustments that should be made by the UAV 200 and/or may determine how the UAV 200 should adjust its mechanical features (e.g., its rudder(s), elevator(s), aileron(s), and/or the speed of its propeller(s)) in order to effectuate such movements. The remote computing system may then communicate such adjustments to the UAV 200 so it can move in the determined manner.

### C. Communication Systems

In a further aspect, the UAV 200 includes one or more communication systems 218. The communications systems 218 may include one or more wireless interfaces and/or one or more wireline interfaces, which allow the UAV 200 to communicate via one or more networks. Such wireless interfaces may provide for communication under one or more wireless communication protocols, such as Bluetooth, WiFi (e.g., an IEEE 802.11 protocol), Long-Term Evolution (LTE), WiMAX (e.g., an IEEE 802.16 standard), a radio-frequency ID (RFID) protocol, near-field communication (NFC), and/or other wireless communication protocols. Such wireline interfaces may include an Ethernet interface, a Universal Serial Bus (USB) interface, or similar interface to communicate via a wire, a twisted pair of wires, a coaxial cable, an optical link, a fiber-optic link, or other physical connection to a wireline network.

In some embodiments, a UAV 200 may include communication systems 218 that allow for both short-range communication and long-range communication. For example, the UAV 200 may be configured for short-range communications using Bluetooth and for long-range communications under a CDMA protocol. In such an embodiment, the UAV 200 may be configured to function as a “hot spot;” or in other words, as a gateway or proxy between a remote support device and one or more data networks, such as a cellular network and/or the Internet. Configured as such, the UAV 200 may facilitate data communications that the remote support device would otherwise be unable to perform by itself.

For example, the UAV 200 may provide a WiFi connection to a remote device, and serve as a proxy or gateway to a cellular service provider's data network, which the UAV might connect to under an LTE or a 3G protocol, for instance. The UAV 200 could also serve as a proxy or gateway to a high-altitude balloon network, a satellite network, or a combination of these networks, among others, which a remote device might not be able to otherwise access.

### D. Power Systems

In a further aspect, the UAV 200 may include power system(s) 220. The power system 220 may include one or more batteries for providing power to the UAV 200. In one example, the one or more batteries may be rechargeable and each battery may be recharged via a wired connection between the battery and a power supply and/or via a wireless charging system, such as an inductive charging system that applies an external time-varying magnetic field to an internal battery.

### E. Payload Delivery

The UAV 200 may employ various systems and configurations in order to transport and deliver a payload 228. In some implementations, the payload 228 of a given UAV 200 may include or take the form of a “package” designed to transport various goods to a target delivery location. For example, the UAV 200 can include a compartment, in which an item or items may be transported. Such a package may include one or more food items, purchased goods, medical items, or any other object(s) having a size and weight suitable to be transported between two locations by the UAV. In other embodiments, a payload 228 may simply be the one or more items that are being delivered (e.g., without any package housing the items).

In some embodiments, the payload 228 may be attached to the UAV and located substantially outside of the UAV during some or all of a flight by the UAV. For example, the package may be tethered or otherwise releasably attached below the UAV during flight to a target location. In some embodiments, the package may include various features that protect its contents from the environment, reduce aerodynamic drag on the system, and prevent the contents of the package from shifting during UAV flight. In other embodiments, the package may be a standard shipping package that is not specifically tailored for UAV flight.

In order to deliver the payload, the UAV may include a winch system 221 controlled by the tether control module 216 in order to lower the payload 228 to the ground while the UAV hovers above. As shown in FIG. 2, the winch system 221 may include a tether 224, and the tether 224 may be coupled to the payload 228 by a payload retriever 226. The tether 224 may be wound on a spool that is coupled to a motor 222 of the UAV. The motor 222 may take the form of a DC motor (e.g., a servo motor) that can be actively controlled by a speed controller. The tether control module 216 can control the speed controller to cause the motor 222 to rotate the spool, thereby unwinding or retracting the tether 224 and lowering or raising the payload retriever 226. In practice, the speed controller may output a desired operating rate (e.g., a desired RPM) for the spool, which may correspond to the speed at which the tether 224 and payload 228 should be lowered towards the ground. The motor 222 may then rotate the spool so that it maintains the desired operating rate.

In order to control the motor 222 via the speed controller, the tether control module 216 may receive data from a speed sensor (e.g., an encoder) configured to convert a mechanical position to a representative analog or digital signal. In particular, the speed sensor may include a rotary encoder that may provide information related to rotary position (and/or rotary movement) of a shaft of the motor or the spool coupled to the motor, among other possibilities. Moreover, the speed sensor may take the form of an absolute encoder and/or an incremental encoder, among others. So in an example implementation, as the motor 222 causes rotation of the spool, a rotary encoder may be used to measure this rotation. In doing so, the rotary encoder may be used to convert a rotary position to an analog or digital electronic signal used by the tether control module 216 to determine the amount of rotation of the spool from a fixed reference angle and/or to an analog or digital electronic signal that is representative of a new rotary position, among other options. Other examples are also possible.

Based on the data from the speed sensor, the tether control module 216 may determine a rotational speed of the motor 222 and/or the spool and responsively control the motor 222 (e.g., by increasing or decreasing an electrical current supplied to the motor 222) to cause the rotational speed of the motor 222 to match a desired speed. When adjusting the motor current, the magnitude of the current adjustment may be based on a proportional-integral-derivative (PID) calculation using the determined and desired speeds of the motor 222. For instance, the magnitude of the current adjustment may be based on a present difference, a past difference (based on accumulated error over time), and a future difference (based on current rates of change) between the determined and desired speeds of the spool.

In some embodiments, the tether control module 216 may vary the rate at which the tether 224 and payload 228 are lowered to the ground. For example, the speed controller may change the desired operating rate according to a variable deployment-rate profile and/or in response to other factors in order to change the rate at which the payload 228 descends toward the ground. To do so, the tether control module 216 may adjust an amount of braking or an amount of friction that is applied to the tether 224. For example, to vary the tether deployment rate, the UAV 200 may include friction pads that can apply a variable amount of pressure to the tether 224. As another example, the UAV 200 can include a motorized braking system that varies the rate at which the spool lets out the tether 224. Such a braking system may take the form of an electromechanical system in which the motor 222 operates to slow the rate at which the spool lets out the tether 224. Further, the motor 222 may vary the amount by which it adjusts the speed (e.g., the RPM) of the spool, and thus may vary the deployment rate of the tether 224. Other examples are also possible.

In some embodiments, the tether control module 216 may be configured to limit the motor current supplied to the motor 222 to a maximum value. With such a limit placed on the motor current, there may be situations where the motor 222 cannot operate at the desired operation specified by the speed controller. For instance, as discussed in more detail below, there may be situations where the speed controller specifies a desired operating rate at which the motor 222 should retract the tether 224 toward the UAV 200, but the motor current may be limited such that a large enough downward force on the tether 224 would counteract the retracting force of the motor 222 and cause the tether 224 to unwind instead. And as further discussed below, a limit on the motor current may be imposed and/or altered depending on an operational state of the UAV 200.

In some embodiments, the tether control module 216 may be configured to determine a status of the tether 224 and/or the payload 228 based on the amount of current supplied to the motor 222. For instance, if a downward force is applied to the tether 224 (e.g., if the payload 228 is attached to the tether 224 or if the tether 224 gets snagged on an object when retracting toward the UAV 200), the tether control module 216 may need to increase the motor current in order to cause the determined rotational speed of the motor 222 and/or spool to match the desired speed. Similarly, when the downward force is removed from the tether 224 (e.g., upon delivery of the payload 228 or removal of a tether snag), the tether control module 216 may need to decrease the motor current in order to cause the determined rotational speed of the motor 222 and/or spool to match the desired speed. As such, the tether control module 216 may be configured to monitor the current supplied to the motor 222. For instance, the tether control module 216 could determine the motor current based on sensor data received from a current sensor of the motor or a current sensor of the power system 220. In any case, based on the current supplied to the motor 222, determine if the payload 228 is attached to the tether 224, if someone or something is pulling on the tether 224, and/or if the payload retriever 226 is pressing against the UAV 200 after retracting the tether 224. Other examples are possible as well.

During delivery of the payload 228, the payload retriever 226 can be configured to secure the payload 228 while being lowered from the UAV by the tether 224, and can be further configured to release the payload 228 upon reaching ground level. The payload retriever 226 can then be retracted to the UAV by reeling in the tether 224 using the motor 222.

In some implementations, the payload 228 may be passively released once it is lowered to the ground. For example, a passive release mechanism may include one or more swing arms adapted to retract into and extend from a housing. An extended swing arm may form a hook on which the payload 228 may be attached. Upon lowering the release mechanism and the payload 228 to the ground via a tether, a gravitational force as well as a downward inertial force on the release mechanism may cause the payload 228 to detach from the hook allowing the release mechanism to be raised upwards toward the UAV. The release mechanism may further include a spring mechanism that biases the swing arm to retract into the housing when there are no other external forces on the swing arm. For instance, a spring may exert a force on the swing arm that pushes or pulls the swing arm toward the housing such that the swing arm retracts into the housing once the weight of the payload 228 no longer forces the swing arm to extend from the housing. Retracting the swing arm into the housing may reduce the likelihood of the release mechanism snagging the payload 228 or other nearby objects when raising the release mechanism toward the UAV upon delivery of the payload 228.

Active payload release mechanisms are also possible. For example, sensors such as a barometric pressure based altimeter and/or accelerometers may help to detect the position of the release mechanism (and the payload) relative to the ground. Data from the sensors can be communicated back to the UAV and/or a control system over a wireless link and used to help in determining when the release mechanism has reached ground level (e.g., by detecting a measurement with the accelerometer that is characteristic of ground impact). In other examples, the UAV may determine that the payload has reached the ground based on a weight sensor detecting a threshold low downward force on the tether and/or based on a threshold low measurement of power drawn by the winch when lowering the payload.

Other systems and techniques for delivering a payload, in addition or in the alternative to a tethered delivery system are also possible. For example, a UAV 200 could include an air-bag drop system or a parachute drop system. Alternatively, a UAV 200 carrying a payload could simply land on the ground at a delivery location. Other examples are also possible.

### IV. Illustrative UAV Deployment Systems

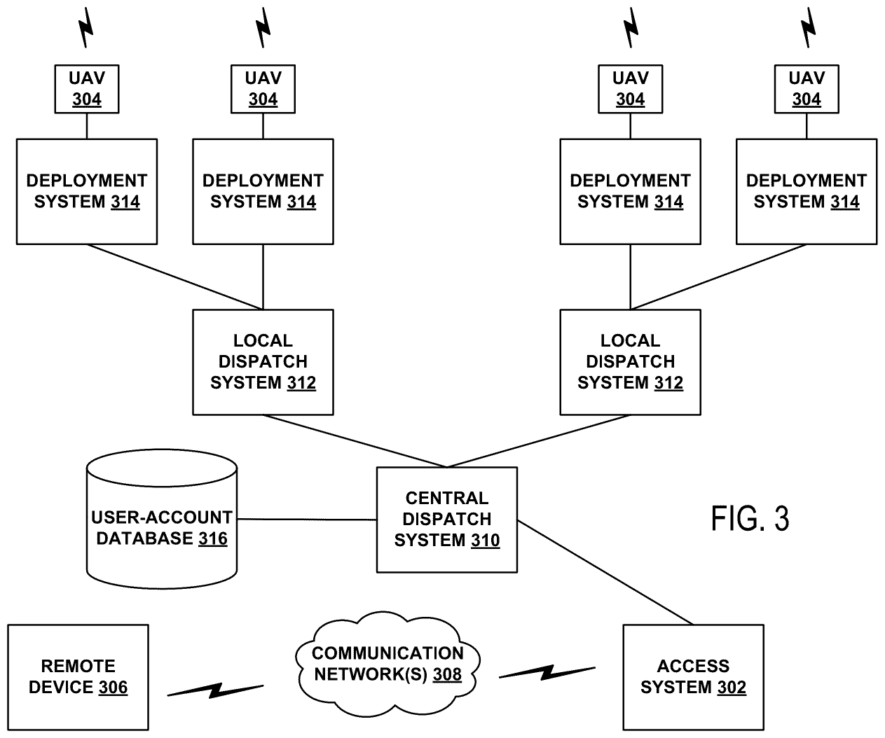

UAV systems may be implemented in order to provide various UAV-related services. In particular, UAVs may be provided at a number of different launch sites that may be in communication with regional and/or central control systems. Such a distributed UAV system may allow UAVs to be quickly deployed to provide services across a large geographic area (e.g., that is much larger than the flight range of any single UAV). For example, UAVs capable of carrying payloads may be distributed at a number of launch sites across a large geographic area (possibly even throughout an entire country, or even worldwide), in order to provide on-demand transport of various items to locations throughout the geographic area. FIG. 3 is a simplified block diagram illustrating a distributed UAV system 300, according to an example embodiment.

In the illustrative UAV system 300, an access system 302 may allow for interaction with, control of, and/or utilization of a network of UAVs 304. In some embodiments, an access system 302 may be a computing system that allows for human-controlled dispatch of UAVs 304. As such, the control system may include or otherwise provide a user interface through which a user can access and/or control the UAVs 304.

In some embodiments, dispatch of the UAVs 304 may additionally or alternatively be accomplished via one or more automated processes. For instance, the access system 302 may dispatch one of the UAVs 304 to transport a payload to a target location, and the UAV may autonomously navigate to the target location by utilizing various on-board sensors, such as a GPS receiver and/or other various navigational sensors.

Further, the access system 302 may provide for remote operation of a UAV. For instance, the access system 302 may allow an operator to control the flight of a UAV via its user interface. As a specific example, an operator may use the access system 302 to dispatch a UAV 304 to a target location. The UAV 304 may then autonomously navigate to the general area of the target location. At this point, the operator may use the access system 302 to take control of the UAV 304 and navigate the UAV to the target location (e.g., to a particular person to whom a payload is being transported). Other examples of remote operation of a UAV are also possible.

In an illustrative embodiment, the UAVs 304 may take various forms. For example, each of the UAVs 304 may be a UAV such as those illustrated in FIGS. 1A-1E. However, UAV system 300 may also utilize other types of UAVs without departing from the scope of the invention. In some implementations, all of the UAVs 304 may be of the same or a similar configuration. However, in other implementations, the UAVs 304 may include a number of different types of UAVs. For instance, the UAVs 304 may include a number of types of UAVs, with each type of UAV being configured for a different type or types of payload delivery capabilities.

The UAV system 300 may further include a remote device 306, which may take various forms. Generally, the remote device 306 may be any device through which a direct or indirect request to dispatch a UAV can be made. (Note that an indirect request may involve any communication that may be responded to by dispatching a UAV, such as requesting a package delivery). In an example embodiment, the remote device 306 may be a mobile phone, tablet computer, laptop computer, personal computer, or any network-connected computing device. Further, in some instances, the remote device 306 may not be a computing device. As an example, a standard telephone, which allows for communication via plain old telephone service (POTS), may serve as the remote device 306. Other types of remote devices are also possible.

Further, the remote device 306 may be configured to communicate with access system 302 via one or more types of communication network(s) 308. For example, the remote device 306 may communicate with the access system 302 (or a human operator of the access system 302) by communicating over a POTS network, a cellular network, and/or a data network such as the Internet. Other types of networks may also be utilized.

In some embodiments, the remote device 306 may be configured to allow a user to request delivery of one or more items to a desired location. For example, a user could request UAV delivery of a package to their home via their mobile phone, tablet, or laptop. As another example, a user could request dynamic delivery to wherever they are located at the time of delivery. To provide such dynamic delivery, the UAV system 300 may receive location information (e.g., GPS coordinates, etc.) from the user's mobile phone, or any other device on the user's person, such that a UAV can navigate to the user's location (as indicated by their mobile phone).

In an illustrative arrangement, the central dispatch system 310 may be a server or group of servers, which is configured to receive dispatch messages requests and/or dispatch instructions from the access system 302. Such dispatch messages may request or instruct the central dispatch system 310 to coordinate the deployment of UAVs to various target locations. The central dispatch system 310 may be further configured to route such requests or instructions to one or more local dispatch systems 312. To provide such functionality, the central dispatch system 310 may communicate with the access system 302 via a data network, such as the Internet or a private network that is established for communications between access systems and automated dispatch systems.

In the illustrated configuration, the central dispatch system 310 may be configured to coordinate the dispatch of UAVs 304 from a number of different local dispatch systems 312. As such, the central dispatch system 310 may keep track of which UAVs 304 are located at which local dispatch systems 312, which UAVs 304 are currently available for deployment, and/or which services or operations each of the UAVs 304 is configured for (in the event that a UAV fleet includes multiple types of UAVs configured for different services and/or operations). Additionally or alternatively, each local dispatch system 312 may be configured to track which of its associated UAVs 304 are currently available for deployment and/or are currently in the midst of item transport.

In some cases, when the central dispatch system 310 receives a request for UAV-related service (e.g., transport of an item) from the access system 302, the central dispatch system 310 may select a specific UAV 304 to dispatch. The central dispatch system 310 may accordingly instruct the local dispatch system 312 that is associated with the selected UAV to dispatch the selected UAV. The local dispatch system 312 may then operate its associated deployment system 314 to launch the selected UAV. In other cases, the central dispatch system 310 may forward a request for a UAV-related service to a local dispatch system 312 that is near the location where the support is requested and leave the selection of a particular UAV 304 to the local dispatch system 312.

In an example configuration, the local dispatch system 312 may be implemented as a computing system at the same location as the deployment system(s) 314 that it controls. For example, the local dispatch system 312 may be implemented by a computing system installed at a building, such as a warehouse, where the deployment system(s) 314 and UAV(s) 304 that are associated with the particular local dispatch system 312 are also located. In other embodiments, the local dispatch system 312 may be implemented at a location that is remote to its associated deployment system(s) 314 and UAV(s) 304.

Numerous variations on and alternatives to the illustrated configuration of the UAV system 300 are possible. For example, in some embodiments, a user of the remote device 306 could request delivery of a package directly from the central dispatch system 310. To do so, an application may be implemented on the remote device 306 that allows the user to provide information regarding a requested delivery, and generate and send a data message to request that the UAV system 300 provide the delivery. In such an embodiment, the central dispatch system 310 may include automated functionality to handle requests that are generated by such an application, evaluate such requests, and, if appropriate, coordinate with an appropriate local dispatch system 312 to deploy a UAV.

Further, some or all of the functionality that is attributed herein to the central dispatch system 310, the local dispatch system(s) 312, the access system 302, and/or the deployment system(s) 314 may be combined in a single system, implemented in a more complex system, and/or redistributed among the central dispatch system 310, the local dispatch system(s) 312, the access system 302, and/or the deployment system(s) 314 in various ways.

Yet further, while each local dispatch system 312 is shown as having two associated deployment systems 314, a given local dispatch system 312 may alternatively have more or fewer associated deployment systems 314. Similarly, while the central dispatch system 310 is shown as being in communication with two local dispatch systems 312, the central dispatch system 310 may alternatively be in communication with more or fewer local dispatch systems 312.

In a further aspect, the deployment systems 314 may take various forms. In general, the deployment systems 314 may take the form of or include systems for physically launching one or more of the UAVs 304. Such launch systems may include features that provide for an automated UAV launch and/or features that allow for a human-assisted UAV launch. Further, the deployment systems 314 may each be configured to launch one particular UAV 304, or to launch multiple UAVs 304.

The deployment systems 314 may further be configured to provide additional functions, including for example, diagnostic-related functions such as verifying system functionality of the UAV, verifying functionality of devices that are housed within a UAV (e.g., a payload delivery apparatus), and/or maintaining devices or other items that are housed in the UAV (e.g., by monitoring a status of a payload such as its temperature, weight, etc.).

In some embodiments, the deployment systems 314 and their corresponding UAVs 304 (and possibly associated local dispatch systems 312) may be strategically distributed throughout an area such as a city. For example, the deployment systems 314 may be strategically distributed such that each deployment system 314 is proximate to one or more payload pickup locations (e.g., near a restaurant, store, or warehouse). However, the deployment systems 314 (and possibly the local dispatch systems 312) may be distributed in other ways, depending upon the particular implementation. As an additional example, kiosks that allow users to transport packages via UAVs may be installed in various locations. Such kiosks may include UAV launch systems, and may allow a user to provide their package for loading onto a UAV and pay for UAV shipping services, among other possibilities. Other examples are also possible.

In a further aspect, the UAV system 300 may include or have access to a user-account database 316. The user-account database 316 may include data for a number of user accounts, and which are each associated with one or more persons. For a given user account, the user-account database 316 may include data related to or useful in providing UAV-related services. Typically, the user data associated with each user account is optionally provided by an associated user and/or is collected with the associated user's permission.

Further, in some embodiments, a person may be required to register for a user account with the UAV system 300, if they wish to be provided with UAV-related services by the UAVs 304 from UAV system 300. As such, the user-account database 316 may include authorization information for a given user account (e.g., a username and password), and/or other information that may be used to authorize access to a user account.

In some embodiments, a person may associate one or more of their devices with their user account, such that they can access the services of UAV system 300. For example, when a person uses an associated mobile phone, e.g., to place a call to an operator of the access system 302 or send a message requesting a UAV-related service to a dispatch system, the phone may be identified via a unique device identification number, and the call or message may then be attributed to the associated user account. Other examples are also possible.

### V. Illustrative Encounter Mitigation for a UAV

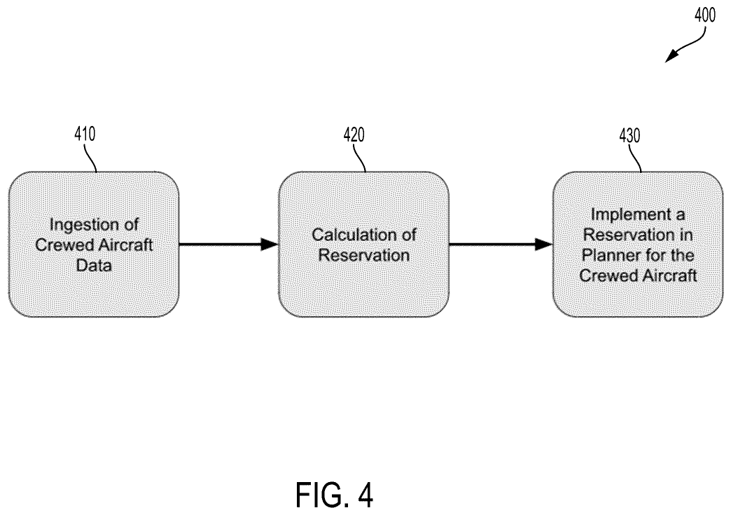

FIG. 4 is a simplified block diagram 400 of traffic encounter mitigation functions within an airspace, in accordance with example embodiments. The block diagram 400 includes block 410, block 420, and block 430. The functions performed in the block diagram 400 may be used for mitigating potential traffic encounters during route planning of a UAV, for example. In some examples, the functions in block 410 through block 430 may each include a set of program instructions stored on a non-transitory data storage. A system may execute the set of program instructions when performing the route planning operation of the UAV.

At block 410 ingestion of crewed aircraft data is performed. Crewed aircraft may include an onboard broadcasting system, such as an automatic dependent surveillance-broadcast (ADS-B) system and/or a transponder. The onboard broadcasting system may periodically broadcast (e.g., transmit) data about the aircraft, such as identification information, current position information, altitude information, and/or velocity information, which allows for tracking of the aircraft. One or more ground sensors may receive the broadcasted data about the crewed aircraft. For example, the one or more ground sensors may receive the current position and/or at least one aircraft parameter for one or more aircraft. In some examples, the one or more ground sensors may be installed in or near a desired flight area such that data is received for the one or more aircraft operating within a given airspace. In some examples, the aircraft may not include the onboard broadcasting system or the onboard broadcasting system may not be properly transmitting data about the aircraft. In such examples, the one or more ground sensors may include another means for receiving information about the aircraft, such as through radar detection, acoustic detection (e.g., a microphone), visual detection (e.g., a camera), and/or a third-party provider.

Within examples of block 410, crewed aircraft data may be received at specified times. For example, the crewed aircraft data may be received prior to launching the UAV. In such examples, the crewed aircraft data may be used to determine potential traffic conflicts along a planned flight path for the UAV within the airspace. However, in other examples the crewed aircraft data may be used to determine a planned flight path for the UAV to avoid encountering the crewed aircraft within the airspace. In some examples, the crewed aircraft data may be received continuously; such as twenty-four hours a day, seven days a week. In such examples, the received crewed aircraft data may be used to develop historical trends for aircraft operating within the airspace. The historical trends may be used to determine future flight path planning operations, such as creating a fixed restriction (e.g., a no-fly zone) within the airspace for areas of high traffic density.

In further examples, one or more UAVs may be currently operating (e.g., flying) within the airspace when sensors onboard an operating UAV detect the crewed aircraft. The one or more UAVs currently operating within the airspace may gather crewed aircraft data from the crewed aircraft and transmit the crewed aircraft data to a receiving system on the ground, such as a ground sensor. The crewed aircraft data captured by the one or more UAVs currently operating within the airspace may be used in conjunction with and/or independent of the crewed aircraft data captured by one or more ground sensors.

At block 420 the received crewed aircraft data of block 410 may be used to determine an airspace reservation for the aircraft. In some examples, a system, such as a computer server system, may be used to determine the airspace reservation. For example the system may determine, based on the current position and the at least one aircraft parameter, an initial volume for each of the one or more aircraft. The system may also determine, based on the current position and the at least one aircraft parameter, a predicted future trajectory for each of the one or more aircraft. The system may further determine, based on the predicted future trajectory and the initial volume, an extended volume for each of the one or more aircraft.

At block 430 the calculated airspace reservation from block 420 may be implemented in a flight planner. The flight planner may include calculated airspace reservations for each of the aircraft operating within the airspace. In some examples, the extended volumes for each aircraft within the airspace may be compiled to form a “map” of all airspace reservations existing within the airspace for a given point in time. For example, the system may additionally determine, based on the extended volume determined for each of the one or more aircraft, a composite extended volume space. The composite extended volume space may be used by the flight planner during route planning operations for the UAV. For example, the system may also plan a flight path for the UAV through the airspace based on the composite extended volume space. In such examples, the flight path may be planned to avoid (e.g., circumvent) one or more airspace reservations in the composite extended volume space. In other examples, a planned flight path may be checked against the airspace reservations in the composite volume space to determine if a traffic conflict is likely. The examples of blocks 410, 420, and 430 are described in more detail below.

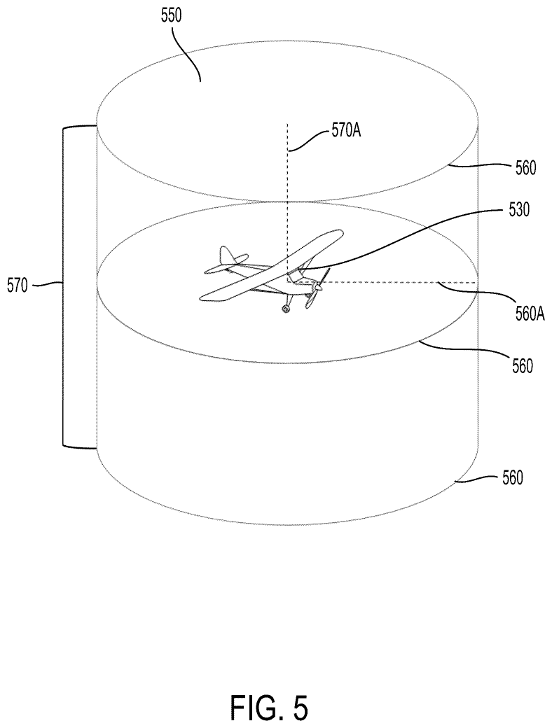

FIG. 5 illustrates an initial volume 550 for an aircraft 530, in accordance with example embodiments. The initial volume 550 is a three-dimensional volume projected around the current position of the aircraft 530 (e.g., the aircraft 530 acting as the locus). The initial volume 550 includes a horizontal area 560 based on a horizontal distance of separation 560A and a height 570 based on a vertical distance of separation 570A from the aircraft 530. Thus, the initial volume 550 defines a three-dimensional distance of separation around the aircraft 530. The initial volume 550 may represent a boundary around the aircraft 530 within which a traffic conflict would be defined.

Data may be received for one or more aircraft currently flying within an airspace. For example, data may be collected on the aircraft 530 as the aircraft 530 is flying within the airspace. The data may include the current position of the aircraft 530, such as altitude and/or location. The data for the aircraft 530 may include one or more aircraft parameters; such as flight information, flight history information, registration information, a make/model, a speed, and/or a heading. In some examples, the data for the aircraft 530 may be used to determine the initial volume 550.

For example, the current position and/or at least one of the aircraft parameters for the aircraft 530 may be used to determine the horizontal distance of separation 560A and/or the vertical distance of separation 570A which may then be used to determine the three-dimensional distance of separation around the aircraft 530, such as the initial volume 550. As shown in FIG. 5, the initial volume 550 is represented by a cylinder having the horizontal area 560 represented by a circle around the aircraft 530. Within examples, the initial volume 550 extends around the current position of the aircraft 530 and includes the three-dimensional shape based on a horizontal distance of separation 560A and the vertical distance of separation 570A from the aircraft 530. The horizontal distance of separation 560A may be a radius originating from the aircraft 530 and horizontally projected around the aircraft 530 to calculate the horizontal area 560. The horizontal area 560 may define a horizontal boundary at all points along the height 570 within which a traffic conflict may be considered.

In the example shown, the height 570 is based on a vertical distance of separation 570A. The vertical distance of separation 570A originates from the aircraft 530 and extends in vertical space above and below the position of the aircraft 530. In some examples, the horizontal distance of separation 560A and/or the vertical distance of separation 570A may be constant for all aircraft flying within an airspace, while in other examples the horizontal distance of separation 560A and/or the vertical distance of separation 570A may vary between aircraft within the airspace (e.g., determined on a case-by-case basis). For example, the horizontal distance of separation 560A and/or the vertical distance of separation 570A may vary based on the make/model of the aircraft 530. A single engine aircraft may have a smaller wingspan and/or lower velocity compared to a larger aircraft, such as a commercial aircraft, however the single engine aircraft may be more maneuverable within a given airspace, and thus potentially less predictable. As another example, a rotary aircraft (e.g., a helicopter) may be more maneuverable in horizontal and/or vertical space compared to a fixed wing aircraft, but may travel at a lower velocity.

Further, position information of the aircraft 530 may be used to determine the horizontal and/or vertical distances of separation 560A and/or 570A. For example, the position information may indicate the aircraft 530 is flying at a low altitude, in close proximity to an airport, with a heading towards an airport. Such position information may allow for the prediction that the aircraft 530 is desiring to land at the airport which may lead to an inference that substantial vertical and/or horizontal changes are unlikely. The horizontal and/or vertical distances of separation 560A and/or 570A may be chosen to reflect said prediction, such as a smaller horizontal distance of separation 560A compared to an aircraft operating at a cruising altitude.

Thus, in some examples the horizontal distance of separation 560A and/or the vertical distance of separation 570A are based on the aircraft position and at least one aircraft parameter. In further examples, the vertical distance of separation 570A may include a first vertical distance of separation above the aircraft 530 and a second vertical distance of separation below the aircraft 530, where the first and second vertical distances of separation are different.

In some examples, the horizontal and/or vertical distance of separation 560A and 570A may account for unforeseeable and/or unpredictable changes in the position of the aircraft 530. The horizontal and/or vertical distance of separation 560A and 570A around the aircraft 530 may provide a buffer space within which minute changes in the position of the aircraft 530 may be made while still flying within the initial volume 550. Thus, the initial volume 550 accounts for a certain amount of uncertainty and/or imprecision with respect to the position of the aircraft 530. Accounting for uncertainty and/or imprecision with respect to the position of the aircraft 530 may decrease the likelihood of a potential traffic conflict because a larger volume of space is considered compared to solely considering a volume space the size of the aircraft 530.

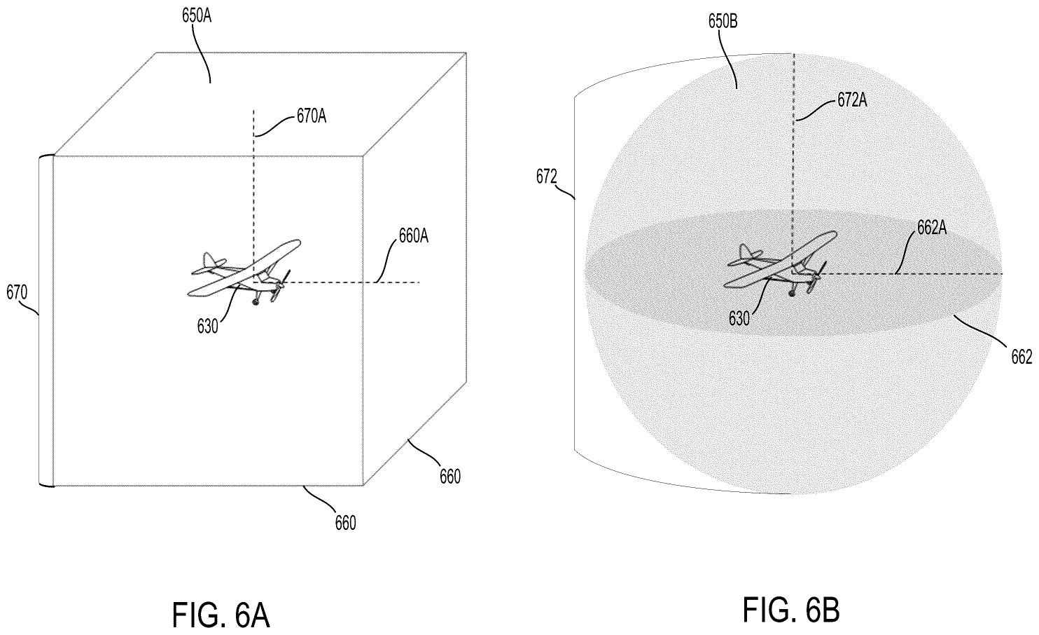

FIGS. 6A-6B are further illustrations of initial volumes 650A and 650B for an aircraft 630, in accordance with example embodiments. In FIG. 6A the initial volume 650A is represented by a box having a horizontal area 660 defined by a horizontal distance of separation 660A from the aircraft 630, and a height 670 defined by a vertical distance of separation 670A from the aircraft 630. In FIG. 6B the initial volume 650B is an ellipsoid defined by a horizontal distance of separation 662A (e.g., a first radius) from the aircraft 630 and a vertical distance of separation 672A (e.g., a second radius) from the aircraft 630. A height 672 of the initial volume 650B may be a maximum vertical distance of separation around the aircraft 630. A horizontal area 662 may be a maximum horizontal distance of separation around the aircraft 630.

The horizontal distances of separation 660A and 662A and/or the vertical distances of separation 670A and 672A may be determined in a similar and/or the same manner as the horizontal and vertical distances of separation 560A and 570A with respect to FIG. 5. While the initial volumes in 650A and 650B are illustrated by the box and the ellipsoid, respectively, other three-dimensional shapes may be used. In some examples, the three-dimensional shape defining the initial volume may be based on the received data, such as the current position and/or the one or more aircraft parameters for the aircraft 630. For example, a rotary aircraft may have an initial volume defined by a first three-dimensional shape, such as the initial volume 650A, and a fixed wing aircraft may have an initial volume defined by a second three-dimensional shape different than the first three-dimensional shape, such as the initial volume 650B. In other examples, the three-dimensional shape may be based on another factor, such as a confidence level.

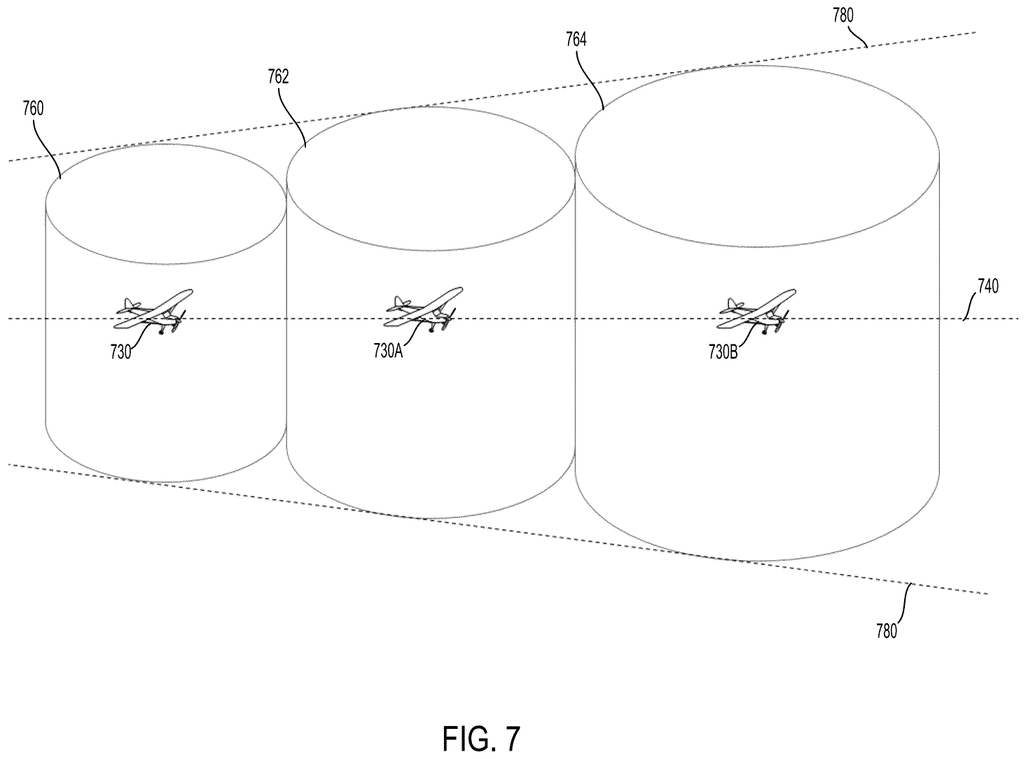

FIG. 7 is an illustration of an extended volume 780 along a predicted future trajectory 740 of an aircraft 730, in accordance with example embodiments. The extended volume 780 includes an initial volume 760 of the aircraft 730 and future encounter volumes 762 and 764 of predicted future positions of the aircraft 730A and 730B for a plurality of discrete future time intervals. The initial volume 760 and future encounter volumes 762 and 764 may be compiled to form an extended volume space along the predicted future trajectory 740. In some examples, the extended volume space is a three-dimensional time dependent volume.

The predicted future trajectory 740 of the aircraft 730 may be a prediction of a position of aircraft 730 at future points in time. For example, within a given airspace, the aircraft 730 may be predicted to execute one or more maneuvers at discrete future time intervals, such as ascending, descending, accelerating, decelerating, turning, and/or continuing at steady level flight. Further, a predicted rate may be determined at which the aircraft 730 executes the maneuver. The maneuver and/or the rate at which the maneuver is executed may impact the predicted future position of the aircraft 730. Information about the aircraft 730 may be utilized in determining the predicted future trajectory 740. For example, the predicted future trajectory 740 of the aircraft 730 may be determined based on received data for the aircraft 730, such as the current position and/or at least one aircraft parameter.

In some examples, the data received for the aircraft 730 may be the same and/or similar to the data received for the aircraft 530, described with respect to FIG. 5. The received data for the aircraft 530 may be used to determine the predicted future trajectory 740, including position of the aircraft 730 at discrete future time intervals. In FIG. 7, the predicted future positions of the aircraft 730 at discrete future time intervals along the predicted future trajectory 740 are represented by 730A and 730B.

As an illustrative example, aircraft position information, flight information, make/model, and/or heading may be used to predict the aircraft 730 may be approaching a runway for landing, and speed information for the aircraft 730 may be used to predict the time it may take the aircraft to reach the runway. The predicted future trajectory 740 may then be drawn as a downwardly sloping path towards the runway. In another illustrative example, a determination may be made from the received data that the aircraft 730 will likely continue along steady level flight (e.g., cruise) at a particular heading. The predicted future trajectory 740 may then be drawn as a substantially straight and level path within the airspace.

In some examples, the future encounter volumes for the aircraft 730 may be constant, while in other examples the future encounter volumes may be non-constant. For example, the future encounter volume may be greater than the initial volume. As illustrated in FIG. 7 the future encounter volumes 762 and 764 around the predicted future positions of the aircraft 730A and 730B, respectively, have varied three-dimensional volumes. The initial volume 760 may be less than the future encounter volume 762 which may be less than another future encounter volume 764. The future encounter volume 764 may represent a predicted future position of the aircraft 730B at a future point in time greater than (e.g., further out) the future encounter volume 762 representing the future position of the aircraft 730A. Thus, in some examples the three-dimensional volume projected around the aircraft 730 may increase along the predicted future flight path 740. In examples where the encounter volume increases along the predicted future flight path 740, the horizontal distance of separation, the vertical distance of separation, and/or both the horizontal and vertical distance of separation may be dynamic with respect to the initial volume 760. For example, the horizontal distance of separation may increase such that the height of the future encounter volume 762 and/or 764 is the same as the initial volume 760 while the horizontal area is larger. In other examples, the vertical distance of separation (e.g., the height) may increase while the horizontal distance of separation of the future encounter volume 762 and/or 764 remains constant with the initial volume 760.

In some examples, a rate at which the future encounter volume size varies from the initial volume may be based on the received data for the aircraft 730 and/or a confidence level. The confidence level may represent a level of uncertainty with respect to future predicted positions of the aircraft (e.g., 730A and/or 730B). As future points in time increase (e.g, become further away from present) the trajectory of the future position of the aircraft 730 may become less predictable. For example, the position of the aircraft 730 at a time 1 second into the future may be more predictable than the position of the aircraft at a time 100 seconds into the future, and thus a confidence level at 1 second into the future may be greater than at 100 seconds into the future. To account for the level of uncertainty with respect to future positions of the aircraft 730A and/or 730B the future encounter volumes 762 and/or 764 may be adjusted to reflect the level of confidence that the aircraft 730 will maintain course along the predicted future trajectory. For example, increasing the future encounter volume may reflect a lower confidence level, while a constant future encounter volume may reflect a higher confidence level. By adjusting the future encounter volumes 762 and/or 764 based on the received data and/or the confidence level, changes in the future position of the aircraft 730A and/or 730B may be accounted for while allowing for a safe distance from the aircraft 730 to be maintained, which may increase overall flight safety.

While the example shown in FIG. 7 includes future encounter volumes 762 and 764, any number of future encounter volumes may be determined. For example, future encounter volumes may be determined for each of a plurality of discrete time intervals along the predicted future trajectory 740 within the airspace. The initial volume 760 and plurality of future encounter volumes may be compiled to form the three-dimensional time dependent volume along the predicted future trajectory 740. A temporary airspace reservation within the three-dimensional time dependent volume of compiled volumes may be created. The temporary airspace reservation may indicate a temporary no-fly space within the airspace while the reservation is active. The temporary airspace reservation may include a set length of time and/or an expiration time. For example, the space within the temporary airspace reservation may last for the set length of time until reaching the expiration time at which the temporary airspace reservation is removed from the airspace. The set length of time and/or the expiration time may be based on received data for the aircraft 730. For example, the reservation time may be based on at least one aircraft parameter, such as a current speed of the aircraft 730.

The examples described above may be performed for a plurality of aircraft operating within the airspace. For example, the initial volume, the future encounter volume, the predicted future flight path, and/or the temporary airspace reservation may be performed for each aircraft (e.g., reporting and/or non-reporting) within the airspace. Flight path operations of the UAV, such as the UAV shown in FIGS. 1A-1E, may be based on one or more temporary airspace reservations within the airspace. For instance, in some examples a flight path of the UAV may be planned around all active temporary airspace reservations existing within the airspace. In other examples, a planned flight path of the UAV may be checked/validated against all active temporary airspace reservations within the airspace. If the planned flight path of the UAV intersects with one or more temporary airspace reservations (e.g., at least one extended volume space), a predicted traffic encounter (e.g., a conflict) may be determined.

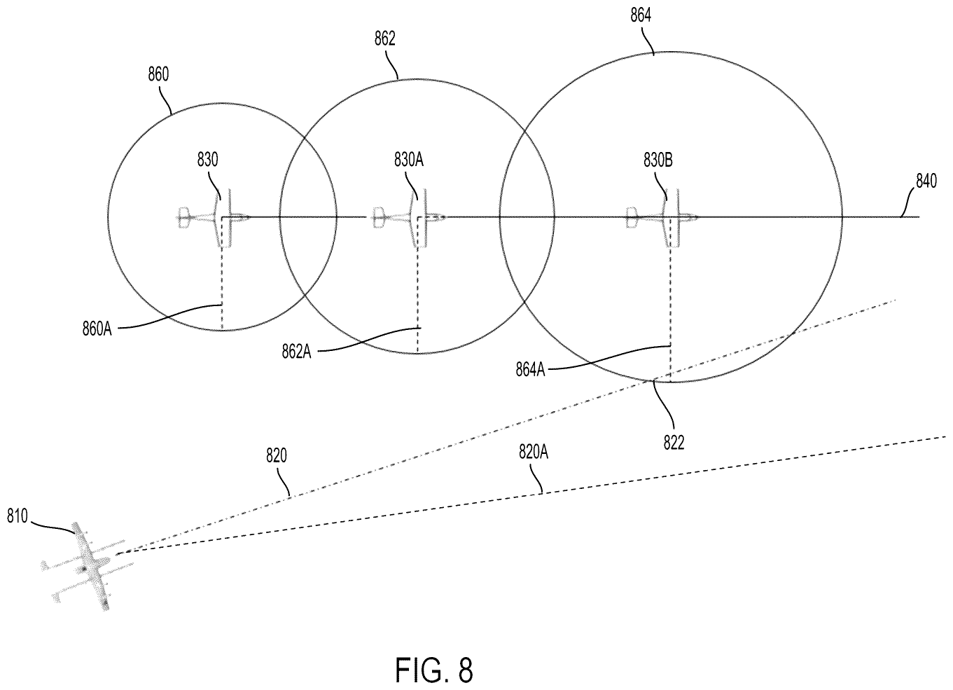

FIG. 8 is a top view illustration of a predicted traffic encounter between a UAV 810 and an aircraft 830, in accordance with example embodiments. The predicted traffic encounter includes a planned flight path 820 for the UAV 810 intersecting at a point 822 with an airspace reservation comprising one or more encounter volumes 860, 862, 864 disposed along a predicted future trajectory 840 of the aircraft 830. The one or more encounter volumes 860, 862, 864 include a horizontal distance of separation 860A, 862A, 864A from a current position or a predicted position of the aircraft 830. The encounter volume 860 is an initial volume around the current position of the aircraft 830. The encounter volumes 862 and 864 represent future encounter volumes extending around predicted aircraft future positions 830A and 830B.

In some examples, the aircraft 830, 830A, and/or 830B; the encounter volumes 860, 862, and/or 864 (e.g., initial volume and future encounter volumes); the horizontal distance of separation 860A, 862A, and/or 864A; and/or the predicted future trajectory 840 may be the same as or similar to examples described above.

The planned flight path 820 may be determined prior to launching/deployment of the UAV 810. For example, the planned flight path 820 may be determined pre-flight while the UAV 810 is not being operated. The planned flight path 820 may be a desired route, within the airspace, for the UAV 810 to travel after deployment. The planned flight path 820 includes a starting point and an end point. In some examples, the start point is a launch point and the end point is a delivery destination. The UAV 810 may travel along the planned flight path 820 to deliver an item at the end point. In further examples, the planned flight path 820 includes a return path from the end point, such as the return path for the UAV 810 to the launch point after delivering the item.

Within the airspace, one or more aircraft, such as the aircraft 830, may be operating at a point in time that the UAV 810 is planned to be operating (e.g., navigating the airspace). Three-dimensional time dependent encounter volumes, as previously described, may be created along the predicted future trajectories for each of the one or more aircraft within the airspace. Temporary airspace reservations corresponding to the three-dimensional time dependent encounter volumes may be placed for each of the one or more aircraft within the airspace. The planned flight path 820 may be checked against the temporary airspace reservations for each of the one or more aircraft (e.g., the aircraft 830) within the airspace to determine whether the predicted traffic encounter is likely.

For example, the planned flight path 820 of the UAV 810 may be predicted to intersect with the temporary airspace reservation for the aircraft 830. In FIG. 8, the planned flight path 820 is predicted to intersect with the future encounter volume 864 at the point 822. Thus, it may be determined that a potential traffic conflict between the UAV 810 and the aircraft 830 is likely and/or creates an unacceptable risk of the traffic encounter occurring. In some examples, a predicted traffic encounter may be determined at any point where the planned flight path 820 intersects the temporary airspace reservation, such as intersecting anywhere vertically and/or horizontally within the three-dimensional time dependent encounter volume.

In some examples, a potential traffic encounter between the UAV 810 and the aircraft 830 may be resolved by comparing the reservation time to the travel time along the planned flight path. For example, each of the extended volumes within the airspace may include a reservation time. A time required for the UAV 810 to reach each point, of a plurality of points, along the planned flight path 820 may be determined. The time required for the UAV 810 to reach each point along the planned flight path 820 may be compared to the reservation time of each of the extended volumes within the airspace of the planned flight path 820. If the reservation time for each of the extended volumes within the airspace of the planned flight path 820 expires prior to the time required for the UAV 810 to reach the point of intersection, such as point 822, then a potential traffic encounter may be determined to be resolved (e.g., no potential traffic encounter may be determined). However, if the UAV 810 will reach the extended volume while the reservation time is active (e.g., the active airspace reservation) then it may be determined that a predicted traffic encounter exists.

In response to the predicted traffic encounter, a launch time for the UAV 810 to begin travel along the planned flight path 820 may be adjusted (e.g., delayed). For example, launching of the UAV 810 along the planned flight path 820 may be adjusted until expiration of the temporary airspace reservation creating the predicted traffic encounter. In other examples, the launch time for the UAV 810 may be delayed until the time required for the UAV 810 to reach the temporary airspace reservation is greater than the time remaining on the reservation time, such that the temporary airspace reservation expires prior to the UAV 810 reaching the point of intersection 822 with the extended volume. In further examples, a new future flight path 820A may be determined for the UAV 810. The new future flight path 820A may be planned to circumvent the extended volumes within the airspace, so as not to conflict with the existing temporary airspace reservations. By adjusting a launch time for the UAV 810 and/or planning a new future flight path 820A around the extended volumes, potential traffic encounters with aircraft operating within the airspace may be mitigated.

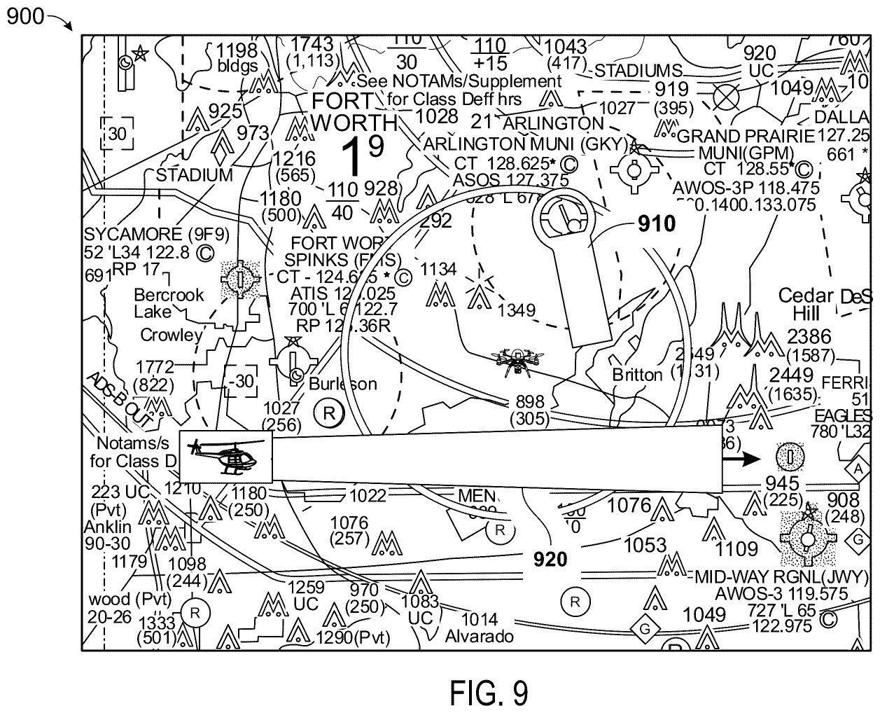

FIG. 9 illustrates a composite extended volume space 900 for an airspace, in accordance with example embodiments. The composite extended volume space 900 includes at least one fixed restriction space 910 and an extended volume 920 for each of the one or more aircraft operating within the airspace.

The extended volume 920 determined for each of the one or more aircraft may be used to determine the composite extended volume space 900. For example, the extended volume 920 may be generated for each of the aircraft within the airspace. Each of the extended volumes 920 at a given point in time may be represented within the airspace to form the composite extended volume space 900. In some examples, the flight path is planned through the airspace based on the composite extended volume space 900. For example, the flight path may be planned through the airspace so as not to encounter each of the extended volumes 920 within the composite extended volume space 900. In other examples, a planned flight path may be validated (e.g., checked) against each of the extended volumes 920 within the composite extended volume space 900 to determine whether a potential traffic conflict exists, such as the planned flight path intersecting with at least one of the extended volumes 920. Based on a determination that the planned flight path intersects with at least one of the extended volumes 920 within the composite extended volume space 900, a new flight path for the UAV, such as the UAV 810, may be determined.

However, in other examples, based on a determination that the planned flight path intersects with at least one of the extended volumes 920 within the composite extended volume space 900, the launch time of the UAV 810 may be delayed until a time when it is determined unlikely that the planned flight path will intersect with one or more extended volumes 920. Thus, within examples a launch time of the UAV 810 may be adjusted based on the determination that the planned flight path intersects with at least one extended volume space 920.

In further examples, based on the determination that the planned flight path intersects with at least one of the extended volume spaces 920, a volume time for each of the extended volume spaces 920 may be determined. The extended volume may be considered resolved upon expiration of the volume time. A time at which all extended volumes intersecting with the planned flight path have been resolved may then be determined. Within examples, the launch time for the UAV 810 is adjusted to the time at which all extended volumes intersecting with the planned flight path have been resolved.

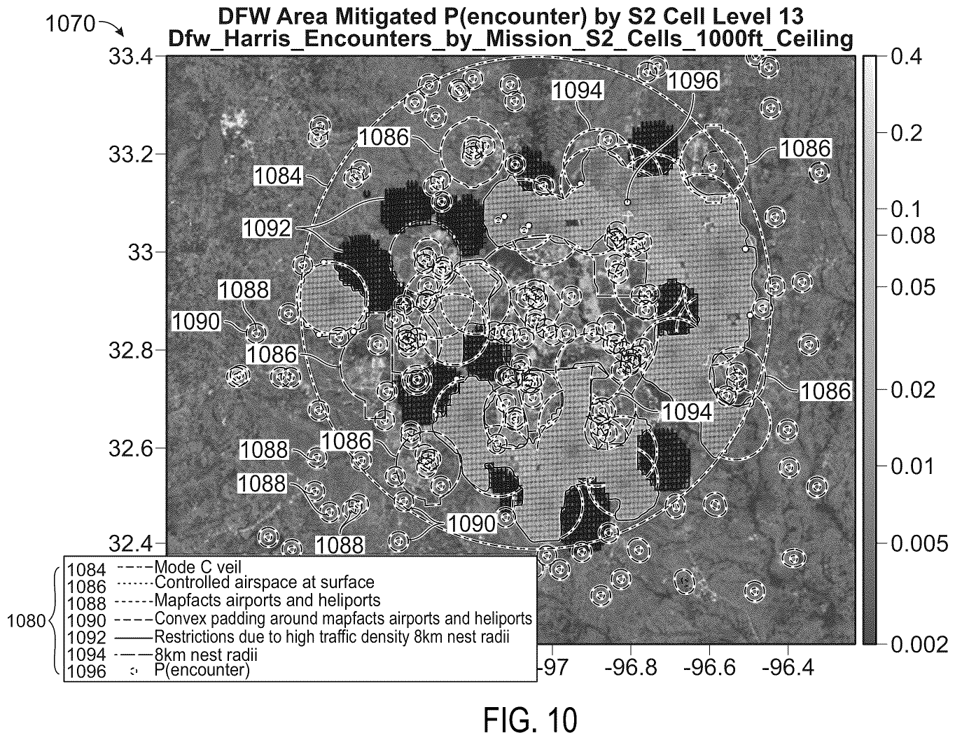

In some examples, current airspace restriction data may be received for the airspace. The current airspace restriction data may be used to determine the fixed restriction space 910. The current airspace restriction data may include portions of the airspace with high traffic density, altitude restrictions, and/or airspace restrictions, for example. The received current airspace restriction data may be included on the composite extended volume space 900 and used in determining the planned future flight path for the UAV 810. The current airspace restriction data is further discussed with respect to FIG. 10.

In other examples, the current airspace restriction data used to determine the fixed restriction space 910 may be separate from the composite extended volume space 900. In such examples, the fixed restriction space 910 may be considered in addition to the composite extended volume space that includes extended volumes 920 for each of the one or more aircraft. For example, the future flight path of the UAV 810 may be determined based on the current airspace restriction data and the composite extended volume space 900.

In some examples, additional constraints on the navigable airspace within which the flight path is planned may be considered. For example, it may be desirable to navigate around portions of the airspace that experience high air traffic density to mitigate delays and/or potential traffic encounters. Airspace restrictions may exist in portions of the airspace that may necessitate navigation around that portion of the airspace. It may also be desirable to navigate around certain features, such as airports, due to airspace restrictions and/or to reduce potential traffic encounters. Further, it may be desirable to operate within certain altitudes and/or boundaries, such as within a regulated flight veil, to provide more transparency of aircraft operating within the airspace. The additional constraints may be fixed restrictions. Unlike the extended volumes determined for aircraft operating within the airspace, the fixed restrictions may have no reservation time in which they expire (e.g., the fixed restrictions are time independent). Within examples, the fixed restrictions may be adjusted over time as more data within the airspace is analyzed and/or circumstances change. For example, a position and/or area of at least one of the fixed restrictions may be adjusted to reflect changed circumstances or analysis of more data within the airspace. The additional constraints may be considered during route planning operations for the UAV 810. Thus, in some examples the composite volume space includes the extended volume determined for one or more aircraft operating within the airspace and one or more airspace parameters.

FIG. 10 illustrates simulated mitigated traffic encounters 1070 for an airspace including a plurality of airspace parameters 1080, in accordance with example embodiments. The plurality of airspace parameters 1080 include a mode C veil 1084, controlled airspace at surface 1086, airports/heliports 1088, a airport/heliport perimeter 1090, a static restricted airspace 1092, a nest radii 1094, and one or more predicted traffic encounters 1096. Each of the plurality of airspace parameters 1080 may represent a constraint considered during planning of the flight path for the UAV, such as UAV 810. The composite extended volume space may include one or more of the plurality of airspace parameters 1080. Thus, during planning of the flight path for the UAV 810, the planned flight path may be based on at least one extended volume space and/or at least one of the plurality of airspace parameters 1080. By varying type and/or number of airspace parameters 1080 considered, the flight path for the UAV 810 may be optimized to mitigate potential traffic encounters with piloted aircraft.

It may be desirable to plan the flight path for the UAV 810 within the mode C veil 1084. The mode C veil 1084 may encompass a thirty nautical mile radii around an airport horizontally and include a flight ceiling of 10,000 feet. Within the mode C veil 1084, most aircraft may be required to include a mode C transponder. Information about the aircraft, such as the current position and/or at least one aircraft parameter, may be transmitted by the transponder and capable of being received by other air or ground based systems. Thus, operating within the mode C veil 1084 may allow for information from aircraft within the airspace to be received, which may provide more precise flight planning and/or reduce the likelihood of a traffic conflict. Further, by operating within the mode C veil 1084, information for aircraft operating outside of the mode C veil 1084 may be excluded, providing a smaller set (e.g., a subset) of aircraft data within the airspace for analysis.

The controlled airspace at surface 1086 includes airspace restrictions below a specified altitude. For example, the controlled airspace at surface 1086 may include a minimum above ground level (AGL) floor due to noise pollution concerns and/or man-made obstacles (e.g., buildings). In such examples, the planned flight path for the UAV 810 may be planned to go around the controlled airspace at surface 1086 or planned to fly through the controlled airspace at surface 1086 above a specified altitude, such as above the minimum AGL floor.

The airport/heliport perimeter 1090 surrounds the airport/heliport 1088. The airport/heliport perimeter 1090 may indicate an airspace restriction that the flight path is not to intersect with. For example, the airport/heliport perimeter 1090 may represent restricted airspace that is a no-fly zone for the UAV 810. In such examples, the flight path may be planned to fly around the airport/heliport perimeter 1090. The airport/heliport perimeter 1090 may be a standardized radii around the airport/heliport 1088 or the airport/heliport perimeter 1090 may be based on a size of the airport/heliport 1088. For example, a larger airport/heliport perimeter 1090 may be set for larger airports/heliports, while a smaller airport/heliport perimeter 1090 may be set for smaller airports/heliports. In some examples the controlled airspace at surface 1086 may surround the airport/heliport perimeter 1090. In such examples, the flight path may be planned through the controlled airspace at surface 1086 but to navigate around the airport/heliport perimeter 1090. Because aircraft takeoff and land at the airport/heliport 1088, planning the flight path around the airport/heliport perimeter 1090 may increase flight safety by reducing a likelihood of the UAV 810 encountering a low flying aircraft approaching or leaving the airport/heliport 1088.

The static restricted airspace 1092 represents flight path restricted regions within the airspace. For example, the flight path is restricted from being charted (e.g., planned) through the static restricted airspace 1092 at all altitudes and the flight path must be planned around the static restricted airspace 1092. Within the airspace, it may become evident over time that certain regions of the airspace exhibit higher than average densities of crewed aircraft activity. The regions exhibiting higher than average densities of crewed aircraft activity (e.g., heavy traffic areas) may present an unacceptable risk of encounter between the aircraft and the UAV 810. Further, the regions exhibiting higher than average densities of crewed aircraft activity may increase the likelihood of flight delays for the UAV 810 which may be undesirable. The heavy traffic areas may be designated as the static restricted airspace 1092 to avoid flight paths being planned through said areas. The static restricted airspace 1092 may reduce the likelihood of a potential traffic conflict and/or reduce delaying a launch time for the UAV 810 by completely avoiding planning flight paths through the static restricted airspace 1092. In some examples, the static restricted airspace 1092 is adjusted over time to account for changing circumstances within the airspace and/or the availability of more aircraft data being analyzed.

The nest radii 1094 represents an outer operation boundary for the UAV 810 originating from a launch point. The UAV 810 may operate within an area defined by the nest radii 1094. Thus, the nest radii 1094 may represent a total range of airspace within which the UAV 810 may operate. For example, the UAV 810 may operate within the nest radii 1094 to pick up a payload from a first location and deliver the payload to a second location. In some examples, the airspace within nest radii 1094 available to the UAV 810 may be further restricted by one or more of the plurality of airspace parameters 1080. For example, the airspace within the nest radii 1094 may include a portion of the static restricted airspace 1092. In such examples, the operable airspace for the UAV 810 may be defined by the nest radii 1094 minus the static restricted airspace 1092 present within the nest radii 1094. However, in other examples another airspace parameter may pose a restriction on the operable airspace of the UAV 810 within the nest radii 1094.

FIG. 10 illustrates the one or more predicted traffic encounters 1096 for the airspace. As illustrated, a number of the predicted traffic encounters 1096 may vary based on the number and/or type of constraints considered within the airspace. By varying the number of constraints and/or the type of constraints considered, a conservative flight path may be planned that accounts for the fixed restrictions while mitigating the number of predicted traffic encounters.

Considering additional constraints within the airspace may allow for planning a more refined flight path that accounts for airspace restrictions and/or areas of high traffic conflict probability. This may reduce delays experienced by the UAV 810 and or reduce the likelihood of encountering aircraft operating within the airspace. Thus, in some examples the composite volume space includes the extended volume determined for one or more aircraft operating within the airspace and one or more of the plurality of airspace parameters 1080.

### VI. Example Method

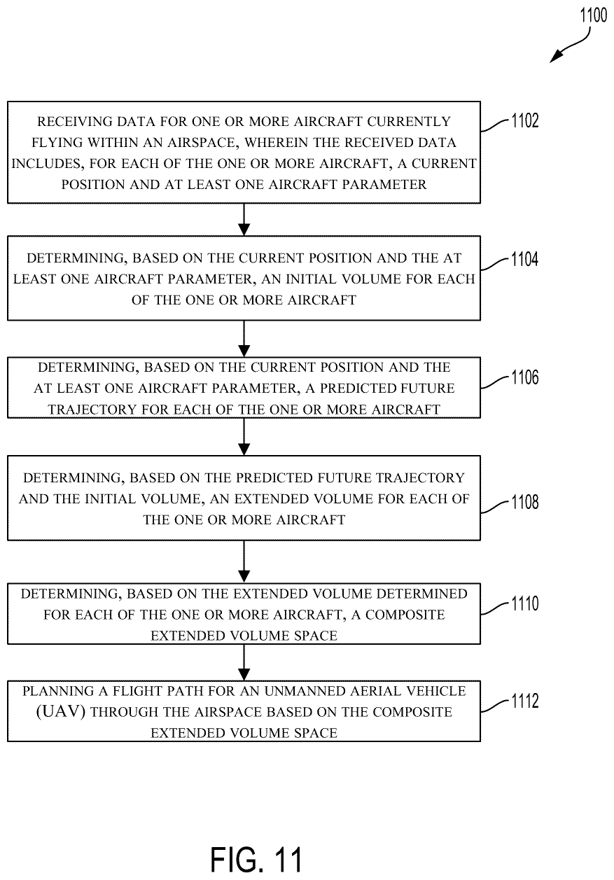

FIG. 11 is a block diagram of method 1100, in accordance with example embodiments. In some examples, method 1100 may be carried out by a control system. In further examples, method 1100 may be carried out by one or more processors, executing program instructions stored in a data storage. Execution of method 1100 may involve a UAV, such as the UAV illustrated and described with respect to FIGS. 1-2. Other UAVs may also be used in the performance of method 1100. In further examples, some or all of the blocks of method 1100 may be performed by a control system remote from the UAV. In yet further examples, different blocks of method 1100 may be performed by different control systems, located remote from a UAV.

As mentioned, FIG. 11 is a block diagram of method 1100, in accordance with example embodiments.

At block 1102, method 1100 includes receiving data for one or more aircraft currently flying within an airspace, wherein the received data includes, for each of the one or more aircraft, a current position and at least one aircraft parameter.

At block 1104, method 1100 includes determining, based on the current position and the at least one aircraft parameter, an initial volume for each of the one or more aircraft.

At block 1106, method 1100 includes determining, based on the current position and the at least one aircraft parameter, a predicted future trajectory for each of the one or more aircraft.

At block 1108, method 1100 includes determining, based on the predicted future trajectory and the initial volume, an extended volume for each of the one or more aircraft.

At block 1110, method 1100 includes determining, based on the extended volume determined for each of the one or more aircraft, a composite extended volume space.

At block 1112, method 1100 includes planning a flight path for an unmanned aerial vehicle (UAV) through the airspace based on the composite extended volume space.

In some examples, the initial volume for each of the one or more aircraft extends around the current position of the aircraft and includes a three-dimensional shape based on a horizontal distance from the aircraft and a vertical distance from the aircraft.

In such examples, the three-dimensional shape may be a cylinder including a horizontal radius.

In some examples, block 1108 of determining the extended volume for an aircraft further includes: determining for each of a plurality of points in time along the predicted future trajectory a minimum horizontal distance and a minimum vertical distance from the aircraft; determining, based on the minimum horizontal and vertical distances, a three-dimensional volume for each point in time; and determining, by compiling the three-dimensional volumes for each point in time, the extended volume.

In such examples, at least one of the minimum horizontal or vertical distance for each point in time may be non-constant.

In further examples, the minimum horizontal distance at a first point in time may be less than the minimum horizontal distance at a second, later, point in time, such that the minimum horizontal distance increases over time.

In further examples, the minimum vertical distance at a first point in time may be less than the minimum vertical distance at a second, later, point in time, such that the minimum vertical distance increases over time.

In such examples, a rate at which the minimum vertical distance increases may be based on aircraft type.

In some examples, each of the extended volumes may include a reservation time. The reservation time may be based on the at least one aircraft parameter.

In such examples, the at least one aircraft parameter may be a current speed of the aircraft.

In some examples, the at least one aircraft parameter includes at least one of a current speed of the aircraft, a type of aircraft, or a heading of the aircraft.

In some examples, each of the extended volumes include a reservation time, and block 1112 of planning the flight path for the UAV further includes: determining, based on a starting point and an end point of the UAV, a time required for the UAV to reach each point of a plurality of points along the flight path; and determining whether the planned flight path intersects with at least one of the extended volumes, where the intersection is based on whether the reservation time for each extended volume will expire prior to the time required for the UAV to reach the extended volume.

In such examples, if it is determined that the UAV will reach the extended volume for an aircraft prior to the volume time expiring, the method 1100 further includes determining a new future flight path around the extended volume.

In some examples, the composite extended volume space further includes at least one fixed restriction space.

In some examples, the method 1100 further includes receiving current airspace restriction data within an airspace; and determining, based on the current airspace restriction data and the composite extended volume space, the planned flight path of the UAV.

In some examples, the method 1100 further includes validating whether a planned flight path for a second UAV intersects with at least one extended volume space.

In such examples, the method 1100 may further include adjusting a launch time of the UAV based on the determination that the planned flight path intersects with the at least one extended volume space.

In such examples, where based on the determination that the planned flight path intersects with the at least one of the extended volumes the method 1100 may further include: determining a volume time for each of the extended volumes, wherein the extended volume is resolved at expiration of the volume time; and determining, a time at which all extended volumes intersecting with the planned flight path have been resolved.

In some examples, the received data on current positions of one or more aircraft may be from a sensor located at ground level, a sensor located on an airborne aircraft, or a third-party provider.

In such examples, the received data from the sensor located on the airborne aircraft may include ADS-B data of crewed aircraft operating at or below 2,000 feet above ground level.

In some examples, the received data at block 1102 may be visually obtained from one or more cameras and/or acoustically obtained from one or more microphones.

### VII. Conclusion

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above-detailed description describes various features and functions of the disclosed systems, devices, and methods with reference to the accompanying figures. In the figures, similar symbols typically identify similar components unless context dictates otherwise. The example embodiments described herein and in the figures are not meant to be limiting. Other embodiments can be utilized, and other changes can be made without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code or related data may be stored on any type of computer-readable medium such as a storage device including a disk or hard drive or other storage medium.

The computer-readable medium may also include non-transitory computer-readable media such as computer-readable media that stores data for short periods of time like register memory, processor cache, and random access memory (RAM). The computer-readable media may also include non-transitory computer-readable media that stores program code or data for longer periods of time, such as secondary or persistent long-term storage, like read-only memory (ROM), optical or magnetic disks, compact-disc read-only memory (CD-ROM), for example. The computer-readable media may also be any other volatile or non-volatile storage systems. A computer-readable medium may be considered a computer-readable storage medium, for example, or a tangible storage device.

Moreover, a block that represents one or more information transmissions may correspond to information transmissions between software or hardware modules in the same physical device. However, other information transmissions may be between software modules or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A method comprising:
receiving data for one or more aircraft currently flying within an airspace, wherein the received data comprises, for each of the one or more aircraft, a current position and at least one aircraft parameter;
determining, based on the current position and the at least one aircraft parameter, an initial volume for each of the one or more aircraft;
determining, based on the current position and the at least one aircraft parameter, a predicted future trajectory for each of the one or more aircraft;
determining, based on the predicted future trajectory and the initial volume, an extended volume for each of the one or more aircraft;
determining, based on the extended volume determined for each of the one or more aircraft, a composite extended volume space; and
planning a flight path for an unmanned aerial vehicle (UAV) through the airspace based on the composite extended volume space.

2. The method of claim 1, wherein the initial volume for each of the one or more aircraft extends around the current position of the aircraft and comprises a three-dimensional shape based on a horizontal distance from the aircraft and a vertical distance from the aircraft.

3. The method of claim 2, wherein the three-dimensional shape is a cylinder comprising a horizontal radius.

4. The method of claim 1, wherein determining the extended volume for an aircraft further comprises:
determining for each of a plurality of points in time along the predicted future trajectory a minimum horizontal distance and a minimum vertical distance from the aircraft;
determining, based on the minimum horizontal and vertical distances, a three-dimensional volume for each point in time; and
determining, by compiling the three-dimensional volumes for each point in time, the extended volume.

5. The method of claim 4, wherein at least one of the minimum horizontal or vertical distance for each point in time is non-constant.

6. The method of claim 4, wherein the minimum horizontal distance at a first point in time is less than the minimum horizontal distance at a second, later, point in time, such that the minimum horizontal distance increases over time.

7. The method of claim 4, wherein the minimum vertical distance at a first point in time is less than the minimum vertical distance at a second, later, point in time, such that the minimum vertical distance increases over time.

8. The method of claim 7, wherein a rate at which the minimum vertical distance increases is based on aircraft type.

9. The method of claim 1, wherein each of the extended volumes include a reservation time, wherein the reservation time is based on the at least one aircraft parameter.

10. The method of claim 9, wherein the at least one aircraft parameter is a current speed of the aircraft.

11. The method of claim 1, wherein the at least one aircraft parameter comprises at least one of a current speed of the aircraft, a type of aircraft, or a heading of the aircraft.

12. The method of claim 1, wherein each of the extended volumes include a reservation time, and planning the flight path for the UAV further comprises:
determining, based on a starting point and an end point of the UAV, a time required for the UAV to reach each point of a plurality of points along the flight path; and
determining whether the planned flight path intersects with at least one of the extended volumes, wherein the intersection is based on whether the reservation time for each extended volume will expire prior to the time required for the UAV to reach the extended volume.

13. The method of claim 12, wherein if it is determined that the UAV will reach the extended volume for an aircraft prior to the volume time expiring, the method further comprises:
determining a new future flight path around the extended volume.

14. The method of claim 1, wherein the composite extended volume space further comprises at least one fixed restriction space.

15. The method of claim 1, further comprising:
receiving current airspace restriction data within an airspace; and
determining, based on the current airspace restriction data and the composite extended volume space, the planned flight path of the UAV.

16. The method of claim 1, further comprising:
validating whether a planned flight path for a second UAV intersects with at least one extended volume space.

17. The method of claim 16, further comprising:
adjusting a launch time of the UAV based on the determination that the planned flight path intersects with the at least one extended volume space.

18. The method of claim 16, wherein based on the determination that the planned flight path intersects with the at least one of the extended volumes the method further comprises:
determining a volume time for each of the extended volumes, wherein the extended volume is resolved at expiration of the volume time; and
determining, a time at which all extended volumes intersecting with the planned flight path have been resolved.

19. The method of claim 1, wherein the received data on current positions of one or more aircraft is from a sensor located at ground level, a sensor located on an airborne aircraft, or a third-party provider.

20. The method of claim 19, wherein the received data from the sensor located on the airborne aircraft comprises ADS-B data of crewed aircraft operating at or below 2,000 feet above ground level.

21. A system comprising:
a processor; and
a non-transitory data storage storing program instructions executable by the processor to carry out operations comprising:
receiving data for one or more aircraft currently flying within an airspace, wherein the received data comprises, for each of the one or more aircraft, a current position and at least one aircraft parameter;
determining, based on the current position and the at least one aircraft parameter, an initial volume for each of the one or more aircraft;
determining, based on the current position and the at least one aircraft parameter, a predicted future trajectory for each of the one or more aircraft;
determining, based on the predicted future trajectory and the initial volume, an extended volume for each of the one or more aircraft;
determining, based on the extended volume determined for each of the one or more aircraft, a composite extended volume space; and
planning a flight path for an unmanned aerial vehicle (UAV) through the airspace based on the composite extended volume space.

22. A non-transitory computer-readable medium having stored thereon program instructions executable by a processor of a device to cause the device to carry out operations comprising:
receiving data for one or more aircraft currently flying within an airspace, wherein the received data comprises, for each of the one or more aircraft, a current position and at least one aircraft parameter;
determining, based on the current position and the at least one aircraft parameter, an initial volume for each of the one or more aircraft;
determining, based on the current position and the at least one aircraft parameter, a predicted future trajectory for each of the one or more aircraft;
determining, based on the predicted future trajectory and the initial volume, an extended volume for each of the one or more aircraft;
determining, based on the extended volume determined for each of the one or more aircraft, a composite extended volume space; and
planning a flight path for an unmanned aerial vehicle (UAV) through the airspace based on the composite extended volume space.
